(19) United States
(12) Patent Application Publication
(10) Pub. No.: US 2009/0103419 A1
(43) Pub. Date: Apr. 23, 2009

(54) Optical Pickup Device, Optical Information Recording and Reproducing Device and Design, Method of Optical Element

(76) Inventors: Kentarou Nakamura, Tokyo (JP); Kohei Ota, Tokyo (JP); Jun Egashira, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/297,534

(22) PCT Filed: Apr. 17, 2007
(86) PCT No.: PCT/JP2007/058325

§ 371 Date: Oct. 17, 2008

(30) Foreign Application Priority Data
Apr. 21, 2006 (JP) 2006 117855

(51) Int. Cl. G11B 7/00

(52) U.S. Cl. 369/112.01; G9B/7

(57) ABSTRACT

In order to provide an optical pickup device, an objective optical element and an optical information recording and reproducing device that can properly record and/or reproduce information with three different recording densities and that can be realized with a simplified structure and at low cost, the optical pickup device is comprised of an optical element, the construction of which is stacked with first, second and third basic structures to make different optical lengths.

### TECHNICAL FIELD

The present invention relates to an optical pickup apparatus, an optical element and optical information recording reproducing apparatus and a method of designing an optical element which can conduct recording and/or reproducing information compatibly for different kinds of optical disks.

### BACKGROUND ART

In recent years, in laser light sources used for reproducing information recorded in optical disks and recording information into optical disks in optical pickup apparatuses, a tendency to make a wavelength of the laser beam shorter has advanced. Then, for example, laser light sources having a wavelength of 400 to 420 nm, such as a blue-violet semiconductor laser and a blue-SHG laser converting the wavelength of an infrared semiconductor laser by utilizing second harmonic waves, have been put to practical use. If these blue-violet laser light sources are used, it becomes possible to record information of 15 to 20 GB into an optical disk having a diameter of 12 cm in the case that an objective lens having the same numeral aperture (NA) as that for a DVD (Digital Versatile Disk) is used, and also it becomes possible to record information of 23 to 25 GB into an optical disk having a diameter of 12 cm in the case that the NA of an objective lens is increased to 0.85. Hereafter, in this specification, an optical disk and a magneto-optical disk employing a blue-violet laser light source are collectively called “a high density optical disk”. All the cases of a case of conducting either one of the recording of information into a disk and the reproducing of information recorded in an optical disk and a case of conducting both the recording and the reproducing are collectively called “recording/reproducing” or “recording and/or reproducing”.

Here, in a high density optical disk by the use of an objective lens having a NA of 0.85, coma aberration caused by skew of an optical disk increase. Therefore, some high density optical disks are designed such that the thickness of a protective layer is made thinner than that of DVD (it is made to 0.1 mm, while that of DVD is 0.6 mm) in order to reduce the comma aberration due to the skew. Here, only a performance capable of conducting recording/reproducing information appropriately for such a type of high density optical disk, it is not said that it has a sufficient worth as a product of an optical disk player/recorder (optical information recording reproducing apparatus). Taking into account the fact that at present, DVDs and CDs (compact disk) having recorded various kinds of information are being sold on the market, it is not sufficient only to be able to record/reproduce information for a high density optical disk. Therefore, for example, if the recording/reproducing of information can be conducted also for DVDs and CDs having been possessed by users, it becomes possible to increase the worth of a product as an optical disk player/recorder for a high density optical disk. Under these backgrounds, it is required for an optical pickup apparatus mounted onto an optical disk player/recorder for a high density optical disk to have a performance capable of recording/reproducing information appropriately while maintaining a compatibility for any one of a high density optical disk and DVD, and further CD.

As a method of making it possible to record/reproduce information appropriately while maintaining a compatibility for any one of a high density optical disk and DVD, and further CD, considered is a method of switching selectively an optical system for a high density optical disk and an optical system for DVD and CD in accordance with the recording density of an optical disk to be recorded/reproduced information. However, since this method needs a plurality of optical systems, it has disadvantages in the points of size and cost.

Therefore, in order to simplify the structure of an optical pickup apparatus and to realize a low cost, even in an optical pickup apparatus having a compatibility, it is necessary to standardize an optical system for a high density optical disk and an optical system for DVD and CD so as to reduce the number of optical components constituting an optical pickup apparatus as small as possible. As a result, the common optical system simplifies the structure of an optical pickup apparatus and becomes advantageous in realizing low cost. Here, in order to attain the common optical system for plural kinds of optical disk different in recording/reproducing wavelength to each other, it is necessary to form an optical path difference providing structure having the wavelength dependency of spherical aberration on at least one optical element on a light converging optical system.

Patent Document 1 discloses an objective optical system having a diffractive structure as an optical path difference providing structure and capable of being used in common to a high density optical disk, a conventional DVD and CD and an optical pickup apparatus incorporating the objective optical system.

Patent Document 1: European Unexamined Patent publication No. 1304689

### DISCLOSURE OF THE INVENTION

### Problem to be Solved by the Invention

However, in the objective lens described in Patent Document 1 and used in an optical pickup apparatus adapted to conduct recording and/or reproducing information compatibly for three different optical disks, there are the following problems. There is a fear that an amount of light used for recording and/or reproducing information becomes shortage depending on a design specification of an optical pickup apparatus, or, there is a case that unnecessary light exert a bad influence to a sensor for tracking at the time of conducting tracking for CD and then it becomes difficult to conduct the tracking for CD accurately. In particular, in the case where an infinite type optical system is used for all three different optical disks, that is, in the case where a parallel light flux enters into an objective lens, the above problems becomes noticeable. Further, in the case where an objective lens is a plastic lens, the problem that a change of a spherical aberration due to a change of temperature becomes large, also becomes noticeable.

Further, in order to solve the above problems, it may be considered to provide a plurality of optical path difference providing structures having respective different optical functions to different optical surfaces. However, in the case of providing different optical path difference providing structures onto different optical surfaces and using them in combination, since the occurrence of aberration due to decentering becomes a problem, another problem that the accuracy in assembling an optical pickup apparatus must be increased in order to avoid the decentering, will be caused.

The present invention was devised with the consideration for the above problems. Therefore, an object of the invention is to provide an optical pickup apparatus, an objective lens and an information recording reproducing apparatus which can conduct appropriately recording and/or reproducing information for three kinds of disks different in recording density such as a high density optical disk, DVD and CD, in addition, to provide an optical pickup apparatus, an objective lens and an information recording reproducing apparatus in which the structures are simple, a decentering error at the time of assembling hardly occur, a low cost can be achieved. Further, another object is to provide an optical pickup apparatus, an objective lens and an information recording reproducing apparatus which can maintain the accuracy of tracking in the case where an infinite type optical system is used for all three different optical disks. Further, another object is to provide an optical pickup apparatus, an objective lens and an information recording reproducing apparatus which can make the temperature characteristics well even if a plastic lens is used as an optical element for a light converging optical system and conduct appropriately recording and/or reproducing information for three kinds of disks.

### Means for Solving the Problem

In order to solve the above problems, the invention described in claim 1 is characterized in that in an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;

the light converging optical system includes at least one optical element,

the optical element has an optical path difference providing structure on an optical surface thereof, and

the optical path difference providing structure is a structure in which at least a first basic structure, a second basic structure and a third basic structure are superimposed on the same surface,

wherein the first basic structure is an optical path difference providing structure to make the amount of r^{th} order diffracted light rays (r is an integer) of the first light flux having passed through the first basic structure larger than the amount of any other-order diffracted light rays, to make the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;

the second basic structure is an optical path difference providing structure to make the amount of u^{th} order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w^{th} order diffracted light rays (w is an integer) of the third light flux larger than the amount of any other order diffracted light rays; and

the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.

The optical pickup apparatus described in claim 2 is the optical pickup apparatus described in claim 1 and characterized in that the optical element provided with the optical path difference providing structure constituted by the superimposition of the first basic structure, the second basic structure and the third basic structure is formed by a single material.

The optical pickup apparatus described in claim 3 is the optical pickup apparatus described in claim 1 or 2 and characterized in that the optical element provided with the optical path difference providing structure constituted by the superimposition of the first basic structure, the second basic structure and the third basic structure is an objective lens made of a plastic.

The optical pickup apparatus described in claim 4 is the optical pickup apparatus described in claim 3 and characterized in that the optical pickup apparatus satisfies the following conditional formula;

0.01<ΔSA/f1<0.05 (1)

where ΔSA represents a difference between a spherical aberration at the time of converging the first light flux on an information recording surface of the first optical disk at a standard working temperature T0 (a standard working wavelength λ10 represents the first wavelength λ1 at the standard working temperature T0) and a spherical aberration at the time of converging the first light flux on an information recording surface of the first optical disk at a working temperature T (|T−T0|<60° C.) different from the standard working temperature T0 (a working wavelength λ11 represents the first wavelength λ0 at the working temperature T), and f1 represents a focal length of an objective included in the light converging optical system at the time of using the first light flux.

The optical pickup apparatus described in claim 5 is the optical pickup apparatus described in claim 4 and characterized in that a structure to superimpose the third basic structure makes it possible for the value of (ΔSA/f1) to satisfy the conditional formula (I).

The optical pickup apparatus described in claim 6 is the optical pickup apparatus described in any of claims 1 to 5 and characterized in that the optical pickup apparatus satisfies the following formulas.

X=10, y=6 and z=5

The optical pickup apparatus described in claim 7 is the optical pickup apparatus described in claim 6 and characterized in that the optical pickup apparatus satisfies the following formulas.

r=0, s=0, t=±1, u=2, V=1, W=1, x=10, y=6 and z=5

The optical pickup apparatus described in claim 8 is the optical pickup apparatus described in any one of claims 1 to 7 and characterized in that the second basic structure comprises plural steps, the third basic structure comprises plural steps, and a pitch width between steps in the third basic structure is larger than that in the second basic structure, wherein the second basic structure and the third basic structure are superimposed in such a way that the position of at least one step in the second basic structure does not conform with that of one step in the third basic structure.

The optical pickup apparatus described in claim 9 is the optical pickup apparatus described in any one of claims 1 to 8 and characterized in that at least one of the first basic structure, the second basic structure and the third basic structure is a blaze type shape.

The optical pickup apparatus described in claim 10 is the optical pickup apparatus described in claim 9 and characterized in that the optical path providing structure constituted by the superimposition of the first basic structure, the second basic structure and the third basic structure has a slanted plane being not perpendicular and parallel to a base plane of the optical element.

An optical element described in claim 11 is characterized in that in an optical element used in a light converging optical system of an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and the light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;

the optical element has an optical path difference providing structure on an optical surface thereof, and

the optical path difference providing structure is constituted such that at least a first basic structure, a second basic structure and a third basic structure are superimposed on the same surface,

wherein the first basic structure is an optical path difference providing structure to make the amount of r^{th} order diffracted light rays (r is an integer) of the first light flux having passed through the first basic structure larger than the amount of any other-order diffracted light rays, to makes the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;

the second basic structure is an optical path difference providing structure to make the amount of u^{th} order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w^{th} order diffracted light rays (w is an integer) of the third light flux larger than the amount of any other order diffracted light rays; and

the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.

The optical element described in claim 12 is the optical element described in claim 11 and characterized in that the optical element provided with the optical path difference providing structure constituted by the superimposition of the first basic structure, the second basic structure and the third basic structure is formed by a single material.

The optical element described in claim 13 is the optical element described in claim 11 or 12 and characterized in that the optical element provided with the optical path difference providing structure constituted by the superimposition of the first basic structure, the second basic structure and the third basic structure is an objective lens made of a plastic.

The optical element described in claim 14 is the optical element described in claim 13 and characterized in that the optical pickup apparatus satisfies the following conditional formula;

0.01<ΔSA/f1<0.05 (1)

where that ΔSA represents a difference between a spherical aberration at the time of converging the first light flux on an information recording surface of the first optical disk at a standard working temperature T0 (a standard working wavelength λ10 represents the first wavelength λ1 at the standard working temperature T0) and a spherical aberration at the time of converging the first light flux on an information recording surface of the first optical disk at a working temperature T (|T−T0|<60° C.) different from the standard working temperature T0 (a working wavelength λ11 represents the first wavelength λ1 at the working temperature T), and f1 represents a focal length of an objective included in the light converging optical system at the time of using the first light flux.

The optical element described in claim 15 is the optical element described in claim 14 and characterized in that a structure to superimpose the third basic structure makes it possible for the value of (ΔSA/f1) to satisfy the conditional formula (I).

The optical element described in claim 16 is the optical element described in any of claims 11 to 15 and characterized in that the optical element satisfies the following formulas.

X=10, y=6 and z=5

The optical element described in claim 17 is the optical element described in claim 16 and characterized in that the optical pickup apparatus satisfies the following formulas.

r=0, s=0, t=±1, u=2, V=1, W=1, x=10, y=6 and z=5

The optical element described in claim 18 is the optical element described in any one of claims 11 to 17 and characterized in that the second basic structure comprises plural steps, the third basic structure comprises plural steps, and a pitch width between steps in the third basic structure is larger than that in the second basic structure, wherein the second basic structure and the third basic structure are superimposed in such a way that the position of at least one step in the second basic structure does not conform with that of one step in the third basic structure.

The optical element described in claim 19 is the optical element described in any one of claims 11 to 18 and characterized in that at least one of the first basic structure, the second basic structure and the third basic structure is a blaze type shape.

The optical element described in claim 20 is the optical pickup apparatus described in claim 19 and characterized in that the optical path providing structure constituted by the superimposition of the first basic structure, the second basic structure and the third basic structure has a slanted plane being not perpendicular and parallel to a base plane of the optical element.

An optical information recording reproducing apparatus described in claim 21 is characterized in that in an optical information recording reproducing apparatus comprising an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;

the light converging optical system of the optical pickup apparatus includes at least one optical element,

the optical element has an optical path difference providing structure on an optical surface thereof, and

the optical path difference providing structure is constituted such that at least a first basic structure, a second basic structure and a third basic structure are superimposed on the same surface,

wherein the first basic structure is an optical path difference providing structure to make the amount of r^{th}order diffracted light rays (r is an integer) of the first light flux having passed through the first basic structure larger than the amount of any other-order diffracted light rays, to make the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;

the second basic structure is an optical path difference providing structure to make the amount of u^{th}order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w^{th} order diffracted light rays (w is an integer) of the third light flux larger than the amount of any other order diffracted light rays; and

the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.

An optical pickup apparatus described in claim 22 is characterized in that in an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;

the light converging optical system includes at least one optical element,

the optical element has an optical path difference providing structure on an optical surface thereof, and

the optical path difference providing structure is constituted such that at least a first basic structure, a second basic structure and a third basic structure are superimposed on the same surface,

wherein the first basic structure, the second basic structure and the third basic structure is a structure having steps shaped in almost the same direction as that of the optical axis, at least one of the first basic structure, the second basic structure and the third basic structure is a structure having a blaze type shape, and the optical path providing structure constituted by the superimposition of the first basic structure, the second basic structure and the third basic structure has a slanted plane being not perpendicular and parallel to a base plane of the optical element.

The optical pickup apparatus described in claim 23 is the optical pickup apparatus described in claim 22 and characterized in that at least one of the first basic structure, the second basic structure and the third basic structure has a stairs type shape.

An optical element described in claim 24 is characterized in that in an optical element used in an light converging optical system of an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;

the optical element has an optical path difference providing structure on an optical surface thereof, and

the optical path difference providing structure is constituted such that at least a first basic structure, a second basic structure and a third basic structure are superimposed on the same surface,

wherein the first basic structure, the second basic structure and the third basic structure is a structure having steps shaped in the same direction as that of the optical axis, at least one of the first basic structure, the second basic structure and the third basic structure is a structure having a blaze type shape, and the optical path providing structure constituted by the superimposition of the first basic structure, the second basic structure and the third basic structure has a slanted plane being not perpendicular and parallel to a base plane of the optical element.

The optical element described in claim 25 is the optical element described in claim 24 and characterized in that at least one of the first basic structure, the second basic structure and the third basic structure has a stairs type shape.

An optical information recording and reproducing apparatus described in claim 26 is characterized in that in an optical information recording and reproducing apparatus comprising an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;

the light converging optical system includes at least one optical element,

the optical element has an optical path difference providing structure on an optical surface thereof, and the optical path difference providing structure is constituted such that at least a first basic structure, a second basic structure and a third basic structure are superimposed on the same surface,

wherein the first basic structure, the second basic structure and the third basic structure is a structure having steps shaped in the same direction as that of the optical axis, at least one of the first basic structure, the second basic structure and the third basic structure is a structure having a blaze type shape, and the optical path providing structure constituted by the superimposition of the first basic structure, the second basic structure and the third basic structure has a slanted plane being not perpendicular and parallel to a base plane of the optical element.

### EFFECT OF THE INVENTION

According to the present invention, it is possible to provide an optical pickup apparatus, an optical element and an optical information recording and reproducing apparatus in which structures are simple, a decentering error hardly occurs at the time of assembling, low cost can be realized, and it is possible to conduct appropriately recording and reproducing information for three kinds of disks different in recording density, such as a high density optical disk, DVD and CD. In addition, in the case of using an infinite type optical system for all the three different optical disks, it becomes possible to maintain the accuracy of tracking. Further, even if a plastic lens is used as an optical element for a light converging optical system, it becomes possible to make the temperature characteristics well and to conduct recording and/or reproducing information appropriately for three kinds of disks.

### BRIEF DESCRIPTION OF THE DRAWING

FIG. 1 is a drawing in which one example of an objective lens OBJ according to the present invention is viewed from the direction of an optical axis.

FIG. 2 is a sectional view showing schematically several examples (a) to (e) of the basic structure according to the present invention.

FIG. 3 is a drawing showing schematically the structure of an optical pickup apparatus according to the present invention.

FIG. 4 is a sectional view showing schematically one example of an objective lens according to the present invention.

FIG. 5 is a sectional view showing an optical path difference providing structure of an objective lens according to the present invention.

FIG. 6 is longitudinal spherical aberration diagrams (a) to (c) with reference to BD, DVD, and CD in examples according to the present invention.

FIG. 7 is a drawing showing schematically the shape of a spot.

### Explanation of Signs

AC Biaxial actuator
PPS Polarizing dichroic prism
CL Collimate lens
LD1 Blue-violet semiconductor laser
LM Laser module
OBJ Objective lens
PL1 Protective substrate
PL2 Protective substrate
PL3 Protective substrate
PU1 Optical pickup apparatus
RL1 Information recording surface
RL2 Information recording surface
RL3 Information recording surface
CN Central area
MD Peripheral area
OT Most peripheral area

### BEST MODE FOR CARRYING OUT THE INVENTION

An optical pickup apparatus according to the present invention comprises at least three light sources of the first light source, the second light source and the third light source. Further, the optical pickup apparatus according to the present invention comprises a light converging optical system to converge the first light flux onto an information recording surface of a first optical disk, to converge the second light flux onto an information recording surface of a second optical disk, and to converge the third light flux onto an information recording surface of a third optical disk. Further, the optical pickup apparatus according to the present invention comprises a light receiving element to receive a reflected light flux from an information recording surface of the first optical disk, the second optical disk or the third optical disk.

The first optical disk comprises a protective substrate having a thickness of t1 and an information recording surface. The second optical disk comprises a protective substrate having a thickness of t2 (t1≦t2) and an information recording surface. The third optical disk comprises a protective substrate having a thickness of t3 (t2<t3) and an information recording surface. It is preferable that the first optical disk is a high density optical disk, the second optical disk is a DVD and the third optical disk is a CD. However, the present invention is not limited to these examples. Further, in the case of (t1≦t2), in comparison with the case of (t1=t2), it is more difficult to conduct recording and/or reproducing for three different optical disks by a single light converging optical system, in particular, by a single optical lens. However, the present invention makes it possible. Here, the first optical disk, the second optical disk and the third optical disk may be a plural layer optical disk having plural information recording surfaces.

In the present specification, one example of the high density optical disk includes an optical disk (for example, BD: blue ray disk) based on the specification that information recording and/or reproducing is conducted by an objective lens having a NA of 0.85 and the thickness of a protective substrate is about 0.1 mm. Further, another example of the high density optical disk includes an optical disk (for example, HD DVD: simply referred to HD) based on the specification that information recording and/or reproducing is conducted by an objective lens having a NA of 0.65 to 0.67 and the thickness of a protective substrate is about 0.6 mm. Further, examples of the high density optical disk include an optical disk having a protective film (in the present specification, the protective substrate includes a protective film) with a thickness of several to several tens nm and an optical disk having a protective substrate with a thickness of 0. Further, examples of the high density optical disk include an optical magnetic disk in which a blue-violet semiconductor laser and a blue-violet SHG laser are used as a light source for information recording and reproducing. Further, in the present specification, the term “DVD” is the collective designation of the DVD type optical disk in which information recording and/or reproducing is conducted by an objective lens having a NA of 0.60 to 0.67 and the thickness of a protective substrate is about 0.6 mm, and DVD includes DVD-ROM, DVD-Video, DVD-Audio, DVD-RAM, DVD-R, DVD-RW, DVD+R, DVD+RW and so on. Further, in the present specification, the term “CD” is the collective designation of the CD type optical disk in which information recording and/or reproducing is conducted by an objective lens having a NA of 0.45 to 0.51 and the thickness of a protective substrate is about 1.2 mm, and CD includes CD-ROM, CD-Audio, CD-Video, CD-R and CD-RW and so on. Here, with regard to the recording density, the recording density of the high density optical disk is the highest, and then becomes low in the order of from DVD to CD.

Herein, with regard to the thickness t1, t2 and t3 of a protective substrate, it may be preferable to satisfy the following conditional formulas. However, the present invention is not limited to these.

0.0750 mm≦t1≦0.1125 mm or 0.5 mm≦t1≦0.7 mm

0.5 mm≦t2≦0.7 mm

1.0 mm≦t3≦1.3 mm

In the present specification, the first light source, the second light source and the third light source are desirably a laser light source. As the laser light source, a semiconductor laser and a silicon laser may be preferably employed. It may preferable that the first wavelength λ1 of the first light flux emitted from the first light source, the second wavelength λ2 (λ2>λ1) of the second light flux emitted from the second light source and the third wavelength λ3 (λ3>λ2) of the third light flux emitted from the third light source satisfy the following conditional formulas.

1.5×λ1<λ2<1.7×λ1

1.9×λ1<λ3<2.1×λ1

Further, in the case where BD or HD, DVD and CD are used as the first optical disk, the second optical disk and the third optical disk respectively, the first wavelength λ1 of the first light source is desirably 350 nm or more and 440 nm or less, and more desirably 380 nm or more and 415 nm or less, the second wavelength λ2 of the second light source is desirably 570 nm or more and 680 nm or less, and more desirably 630 nm or more and 670 nm or less, and the third wavelength λ3 of the third light source is desirably 750 nm or more and 880 nm or less, and more desirably 760 nm or more and 820 nm or less.

At least two light sources among the first light source, the second light source and the third light source may be unitized to a unit. The unitization means the constitution that for example, the first light source and the second light source are fixed and accommodated in a single package. However, it is not limited to the above constitution, it includes widely the condition that two light sources are fixed so as to be unable to correct aberration. Further, in addition to the light sources, light receiving elements mentioned layer may be unitized into one package.

As the light receiving elements, a photo detecting device such as a photodiode and so on may be preferably employed. Light reflected from an information recording surface of an optical disk enters into the light receiving element and read-out signals of information recorded in each optical disk are obtained by the use of output signals of the light receiving element. Focus detection and track detection are conducted by detecting the change in the shape of a spot on the light receiving element or the change in a light amount due to positional change and, based on these detections, it possible to shift an objective lens for focusing and tracking. The light receiving element may be composed of plural light detecting devices. The light receiving element may comprise a main light detecting device and a subsidiary light detecting device. For example, the light receiving element may be constituted such that two subsidiary light detecting devices are provided at both sides of a light receiving device to receive main light used for information recording and reproducing and the two subsidiary light detecting devices are adapted to receive subsidiary light used for adjusting tracking. Further, the light receiving element may comprise plural light receiving elements corresponding to plural light sources.

The light converging optical system comprises at least one optical element such as an objective lens. The light converging optical system may comprise only an objective lens. However, the light converging optical system may also have a coupling lens such as a collimator lens and other optical elements such as a flat plate-shaped optical element having an optical function in addition to the objective lens. The coupling lens is arranged between the objective lens and the light source and means a single lens or a lens group which changes divergent angle of a light flux. The collimator lens is a lens to collimate the light flux entered into the collimator lens. Further, the light converging optical system may also comprise an optical element such as the diffractive optical element which divides the light flux emitted from the light source into a main light flux used for recording reproducing information and two subsidiary light fluxes used for the tracking operation. In the present specification, the objective lens means an optical system which is arranged to face the optical disk in the optical pickup apparatus, which has the function which converges the light flux emitted from the light source onto an information recording surface of the optical disk. Preferably, the objective lens is an optical system which is arranged to face the optical disk in the optical pickup apparatus, and which has the function which converges the light flux emitted from the light source on the information recording surface of the optical disk, and further which is movable as one body in the direction of at least the optical axis by an actuator.

An optical element which is an optical lens used in a light converging optical system and is provided with an optical path difference providing structure, may be formed of a plurality of lenses and optical elements. Alternatively, the optical element may be a single lens. Preferably, the optical element is formed of a single lens or a single optical element. The optical element may also be a glass lens, a plastic lens or a hybrid optical element in which an optical path difference providing structure is formed on a glass optical element with a thermosetting resin. However, it is preferably formed of a single material. When the optical element has a plurality of lenses, a glass lens and a plastic lens may be used in combination. When the optical element has a plurality of lenses, a flat plate-shaped optical element having an optical path difference providing structure and an aspheric lens which may or may not have a optical path difference providing structure, are used in combination as the optical element. Further, when the optical element is a lens, the lens comprises preferably a refractive surface being an aspheric surface. Further, the optical element has a base surface provided with an optical path difference providing structure and the base surface is preferably an aspheric surface or a flat surface. Here, in the case that an optical surface of an optical element provided with an optical path difference providing structure is a flat surface, the base surface represents the flat surface, and in the case that an optical surface of an optical element provided with an optical path difference providing structure is a curved surface, the base surface represents an enveloping surface of the optical path difference providing structure. The enveloping surface is formed by curve lines connecting portions projecting most largely in a direction of an optical axis for each unit area. As the unit area, an optical surface may be divided for every 0.05 mm in a direction perpendicular to an optical axis. The optical element provided with an optical path difference providing structure is especially preferably a single objective lens made of a plastic or a single flat plate-shaped optical element made of a plastic.

Further, when the optical element is a glass lens, a glass material used for the glass lens preferably has a glass transition point Tg of 400° C. or less. By using the glass material whose glass transition point Tg is 400° C. or less, the material can be molded at a comparatively low temperature. Therefore, the life of the metallic mold can be prolonged. As an example of the glass material whose glass transition point Tg is low, there are K-PG325 and K-PG375 (both are trade names) made by SUMITA Optical glass, Inc.

Here, a glass lens has generally larger specific gravity than a resin lens. Therefore, the objective lens made of a glass lens has larger weight and apply a larger burden to an actuator which drives the objective lens. Therefore, when an optical element is made from a glass material, it is preferable to us a glass material having small specific gravity. Specifically, the specific gravity is preferably 3.0 or less, and is more preferably 2.8 or less.

Further, when an optical lens such as an objective lens is made from a plastic, it is preferable to use a cyclic olefin type resin material. In the cyclic olefin type, it is more preferable to use a resin material having a refractive index being within a range of 1.54 to 1.60 at a temperature of 25° C. for a wavelength of 405 nm and a change ratio of refractive index dN/dT (° C.−1) of −20×10⁻⁵ to −5×10⁻⁵ (more preferably, −10×10⁻⁵ to −8×10⁻⁵) with a change of temperature within a temperature range of −5° C. to 70° C. for a wavelength of 405 nm. Further, when a plastic lens is employed for an objective lens, it is preferable that a plastic lens is also employed for a coupling lens.

Alternatively, as a resin material appropriate to the objective lens of the present invention, “athermal resin” may be also employed other than the cyclic olefin type. The “athermal resin” is a resin material in which microparticles each having the change ratio of refractive index with a reverse sign to the change ratio of the refractive index of the resin of a base material due to a change of temperature and a diameter of 30 nm or less are dispersed.

An optical element having an optical path difference providing structure will be explained hereafter. The optical path difference providing structure is a structure in which the first basic structure, the second basic structure and the third basic structure are superimposed on the same surface. The term “superimposition” means literally “to superimpose”. In the present specification, in the case that the first basic structure and the second basic structure are provided onto different optical surfaces respectively, or in the case that even if the first basic structure and the second basic structure are provided on the same optical surface, they are provided onto different areas and there is no superimposed area, the first basic structure and the second basic structure are not superimposed in the present specification. Further, in the optical path difference providing structure of the present specification, at least three basic structures may superimposed, and in addition, another basic structure may be superimposed. For example, in addition to the first basic structure, the second basic structure and the third basic structure, the fourth basic structure may be superimposed, and further the fifth basic structure may be superimposed. Here, all the basic structures are respective optical path providing structures.

Here, in the present specification, the term “optical path difference providing structure” is the collective designation of a structure to add an optical path difference to an incident light flux. The optical path difference providing structure includes a phase difference providing structure to provide a phase difference. Further, the phase difference providing structure includes a diffractive structure. The optical path difference providing structure comprises a step parallel to the direction of an optical axis, and preferably comprises plural steps. An incident light flux is added with an optical path difference and/or phase difference. The optical path difference added by the optical path difference providing structure may be equal to an integral multiple of the wavelength of the incident light flux or may be equal to a non-integral multiple of the wavelength of an incident light flux. Here, it may be preferable that a basic structure such as the first basic structure, the second basic structure and the third basic structure is made the structure of concentric circles around the center of an optical axis when the basic structure is viewed from the direction of the optical axis.

The first basic structure is an optical path difference providing structure to make the amount of r^{th}-order diffracted light rays (r is an integer) of the first light flux having passed through the first basic structure larger than the amount of any other-order diffracted light rays, to make the amount of s^{th}-order diffracted light rays (s is an integer) of the second light flux larger than the amount of any other-order diffracted light rays, and to make the amount of t^{th}-order diffracted light rays (t is an integer) of the third light flux larger than the amount of any other-order diffracted light rays. The second basic structure is an optical path difference providing structure to make the amount of u^{th}-order diffracted light rays (u is an integer) of the first light flux having passed through the second basic structure larger than the amount of any other-order diffracted light rays, to make the amount of v^{th}-order diffracted light rays (v is an integer) of the second light flux larger than the amount of any other-order diffracted light rays, and to make the amount of w^{th}-order diffracted light rays (w is an integer) of the third light flux larger than the amount of any other-order diffracted light rays. The third basic structure is an optical path difference providing structure to make the amount of x^{th}-order diffracted light rays (x is an integer) of the first light flux having passed through the third basic structure larger than the amount of any other-order diffracted light rays, to make the amount of y^{th}-order diffracted light rays (y is an integer) of the second light flux larger than the amount of any other-order diffracted light rays, and to make the amount of z^{th}-order diffracted light rays (z is an integer) of the third light flux larger than the amount of any other-order diffracted light rays.

A part of r, s, t, u, v, w, x, y and z may be the same integer and all of them may be different integer. However, all of them never become the same integer. At least one of r, s and t is not preferably 0. One or two of r, s and t may be 0. At least one of u, v and w is not preferably 0. More preferably, none of u, v and w is not 0. At least one of x, y and z is not preferably 0. More preferably, none of x, y and z is not 0. Further, it may be preferable to satisfy the following conditional formula.

r+s+t<u+v+w<x+y+z

The first structure, the second structure and the third structure is preferably a structure in which a unit shape is repeated periodically. Here, the term “a unit shape is repeated periodically” naturally includes a configuration in which the same shape is repeated with the same interval. Further, the term “a unit shape is repeated periodically” includes a configuration in which in a unit shape being a unit of an interval, the interval becomes gradually longer with a regularity or becomes gradually shorter.

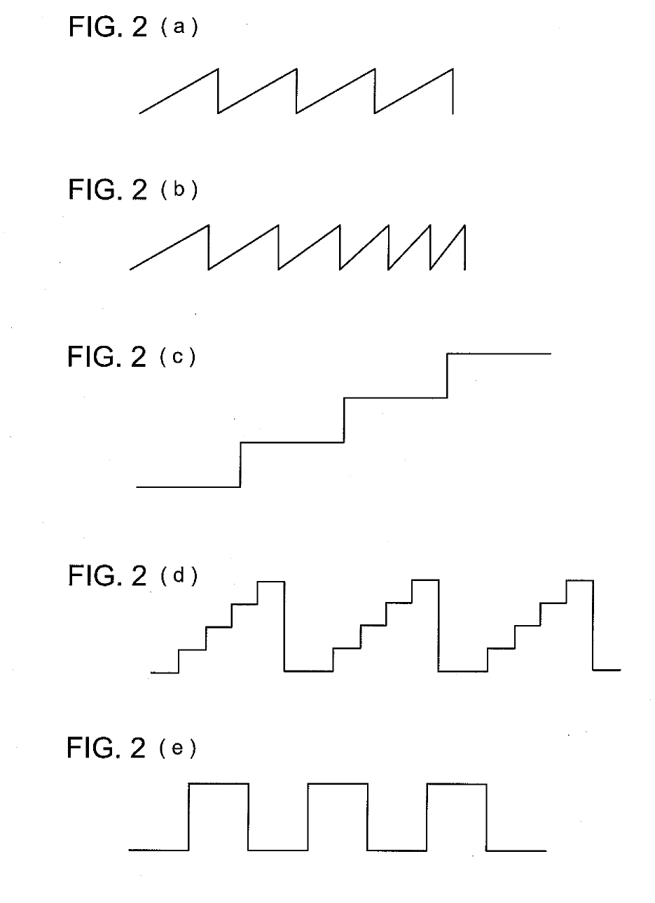

For example, at least one of the first basic structure, the second basic structure and the third basic structure preferably has a blaze type shape. As shown in FIGS. 2(a) and 2(b), the blaze type shape is shaped such that a cross-sectional shape including an optical axis of an optical element comprising the optical path difference providing structure is like the shape of a saw tooth. In other words, the optical path difference structure comprises a slanted plane being not perpendicular or parallel to a base plane. Here, the base plane has been already stated above. Further, in the present invention, all the basic structure such as the first basic structure, the second basic structure and the third basic structure may be limited to the blaze type basic structure.

In the case that the first basic structure, the second basic structure and the third basic structure comprise the blaze type structure, the blaze type structure is shaped such that a triangular shape being a unit shape is repeated. As shown in FIG. 2(a), the same triangular shape may be repeated. As shown in FIG. 2(b), as the position of the triangular shape advances toward the base plane, the size of the triangular shape may become gradually large or the size of the triangular shape may become gradually small. Further, the blaze type structure is shaped so as to combine the configuration in which the size of the triangular shape becomes gradually large and the configuration in which the size of the triangular shape becomes gradually small. However, even in the case that the size of the triangular shape gradually changes, it may be preferable that the dimension of the triangular shape in the direction of the optical path (or the direction in which light rays pass through) hardly change. Here, in the blaze type structure, the length of one triangular shape in the direction of the optical axis (or the length in the direction in which light rays pass through) is called a pitch depth and the length of one triangular shape perpendicular to the direction of the optical axis is called a pitch width. In addition, in some area, the step of the blaze type structure is shaped so as to face to the reverse direction to the direction toward the optical axis side (the center); in another area, the step of the blaze type structure is shaped so as to face to the direction toward the optical axis side (the center); and an intermediate area between the some area and the another area is shaped to provide a transition area necessary for switching the facing direction of the step of the blaze type structure. When an optical path to be added to the passing wave front by a diffractive structure is expressed with an optical path difference function, the transition area is an area corresponding to a point where the optical path difference function has the extreme value. Here, if the optical path difference function has a point becoming the extreme value, since the inclination of the optical path difference function becomes small, it becomes possible to widen the pitch of ring-shaped zones. As a result, the lowering of the transmission ratio due to an error in the shape of a diffractive structure can be suppressed. Herein, even if an order such as r, s and t is the same, in the case that a basic structure having a different shape is superimposed or a basic structure having the same order is dislocated and superimposed, it may be deemed that these are different basic structures.

Further, at least one of the first basic structure, the second basic structure and the third basic structure may be a stairs type shape as shown in FIGS. 2(c) and 2(d). The stairs type shape means that a cross-sectional shape including an optical axis of an optical element comprising the optical path difference providing structure is like a stairs. In other words, the optical path difference providing structure consists of only a parallel plane to a base plane and a parallel plane to an optical axis and does not comprises a slanted plane to the base plane. As the position on the optical path difference providing structure advances toward the direction of the base plane, the length in the direction of the optical axis changes stepwise. Here, for example, in the case that r=0, s=1, and t=0, the first basic structure becomes the stairs type shape as shown in FIG. 2(d). However, since this shape is also said as the superimposition of two blaze type shapes, this shape may be deemed as the superimposition of two basic structures.

In the case that the first basic structure, the second basic structure and the third basic structure have the stairs type shape, these structures become a configuration in which a stairs shape as a unit shape is repeated. For example, there may be a configuration in which a step in the stairs becomes gradually higher as shown in FIG. 2(c), and a configuration in which the same small stairs having several steps (for example, four steps or five steps) is repeated as shown in FIG. 2(d). Further, these structures may be a configuration in which as the position on these structures advances in the direction to the base plane, the size of a stairs becomes larger or the size of a stairs becomes smaller. However, in this case, it may desirable that the length in the direction of an optical axis (or, the direction of passing light rays) is not almost changed.

Further, either one of the first basic structure, the second basic structure and the third basic structure may a binary type shape as shown in FIG. 2(e). Further, as the position on these structures advances in the direction to the base plane, the shape may be a shape in which the size of a binary becomes gradually larger or the size of a binary becomes gradually smaller. However, in this case, it may desirable that the length in the direction of passing light rays is not almost changed. Here, for example, in the case that r=0, s=0, and t=±1, the first basic structure becomes a binary type shape as shown in FIG. 2(e). However, since this shape is also said as the superimposition of two blaze type shapes, this shape may be deemed as the superimposition of two basic structures.

In the shape of an optical path difference providing structure in which the first basic structure, the second basic structure and the third basic structure are superimposed, it may be desirable to remain the trace of a blaze type shape of the first basic structure, the second basic structure and the third basic structure. In other words, it may be desirable that an optical path difference providing structure in which the first basic structure, the second basic structure and the third basic structure are superimposed, has a slanted plane being not perpendicular and parallel to a base plane on of an optical element which the optical path difference providing structure is provided. With the structure to make this shape, in the first basic structure, the second basic structure and the third basic structure, it becomes possible to prevent the reduction or loss of optical functions intended to be provided (for example, functions to improve temperature characteristics, to improve wavelength characteristics and to diffract only a specific wavelength). Therefore, in the superimposed optical path difference providing structure, the intended optical functions can be performed.

Further, among the first basic structure, the second basic structure and the third basic structure, with regard to at least two basic structures of a blaze type basic structure having a larger pitch width (or, the width of a cycle) and a blaze type basic structure having a smaller pitch width (or, the width of a cycle) in comparison with the above, in the case of superimposing the two basic structures, it desirable that at least one of positions of steps (a plane almost perpendicular to the base plane) the basic structure having the larger pitch width (or, the width of a cycle) does not coincide with the positions of steps of the basic structure having the smaller pitch width (or, the width of a cycle). In other words, it is preferable to shift the positions of steps to each other in such a way that the cycle of the larger basic structure does not coincide with an integral multiplication of the cycle of the smaller basic structure. With this superimposition, it is preferable to be able to remain the trace of the abovementioned blaze type shape.

Further, it is desirable that the first basic structure and the second basic structure are a structure to provide a diffractive action to adjust a spherical aberration caused at the time of using the first optical disk, a spherical aberration caused at the time of using the second optical disk, and a spherical aberration caused at the time of using the third optical disk to a desired value. Hereafter, this structure is called a compatible structure. In particular, it is desirable that the first basic structure is a structure to correct a spherical aberration caused on the basis of a difference in thickness of a transparent basic substrate between the first optical disk and the third optical disk by utilizing a difference in wavelength between the first light flux and the third light flux. Further, it is desirable that the second basic structure is a structure to correct a spherical aberration caused on the basis of a difference in thickness of a transparent basic substrate between the first optical disk and the second optical disk by utilizing a difference in wavelength between the first light flux and the second light flux.

Meanwhile, it is desirable that the third basic structure and a fourth basic structure and a fifth basic structure which are mentioned later, are a structure to correct an aberration caused when ambient temperature changes. Hereafter, this structure is called a temperature change compensating structure. The third basic structure, the fourth basic structure and the fifth basic structure may be a structure to correct an aberration caused by a change of a refractive index when the refractive index of an objective lens changes due to a change of ambient temperature by utilizing a change of wavelength changing slightly (about within ±10 nm) due to the change of ambient temperature. Further, the third basic structure, the fourth basic structure and the fifth basic structure causes a change of phase difference in steps of a basic structure by utilizing a change of refractive index due to a change of ambient temperature and corrects an aberration caused with the change of the ambient temperature by utilizing the change of the phase difference. Herein, the first basic structure and the second basic structure are constituted on the same base plane and only the third basic structure is constituted on a different base plane.

Here, in the case where an objective lens having an aspherical surface is designed as an optical element of the present invention, a preferable design method will be described. First, an aspherical surface is designed as a base plane, and then a structure which is a basic structure having the largest pitch width and in which the values of r, s and t are set respectively, is designed as the first basic structure so as to be provided on the aspherical surface. Next, a structure which is a basic structure having a large pitch width following that of the first basic structure for respective plains within each pitch width of the first basic structure and in which the values of u, v and w are set respectively, is designed as the second basic structure so as to be superimposed on the first basic structure. Further, a structure which is a basic structure having a large pitch width following that of the second basic structure for respective plains within each pitch width of the first basic structure and in which the values of x, y and z are set respectively, is designed as the third basic structure so as to be superimposed on the first basic structure and the second basic structure. In the case where the fourth basic structure and the following structures after the fourth basic structure are provided, the above works may be repeated. As described above, it is desirable that basic structures may be superimposed sequentially from a basic structure having a wider pitch width. Herein, the first basic structure, the second basic structure and the third basic structure are designed respectively, and finally these basic structures may be superimposed on the base plane. However, the above-mentioned method is more preferable.

The first basic structure and the second basic structure are preferably designed by the use of an optical path difference function and the third basic structure is preferably designed by the use of the formula of aspherical surface employing aspherical coefficients. However, the present invention is not limited to this method.

In the case that an optical element comprising an optical path difference providing structure is a single objective lens made of a plastic, as the optical pickup apparatus, it is preferable to satisfy the following conditional formula.

0.01<ΔSA/f1<0.05 (1)

Here, ΔSA represents the difference between a spherical aberration at the time of converging the first light flux on an information recording surface of the first optical disk at a standard working temperature T0 (a standard working wavelength λ10 represents the first wavelength λ0 at the standard working temperature T0) and a spherical aberration at the time of converging the first light flux on an information recording surface of the first optical disk at a working temperature T (|T−T0|<60° C.) different from the standard working temperature T0 (the working wavelength λ11 represents the first wavelength λ0 at the working temperature T), and f1 represents a focal length of an objective included in the light converging optical system at the time of using the first light flux. Here, it is desirable that T0 is within a range of 15° C. or more and 25° C. or less.

It may be more desirable to satisfy the following conditional formula.

0.01<ΔSA/f1<0.03 (1′)

Here, in the optical path difference providing structure provided on a plastic optical element, among the first basic structure, the second basic structure and the third basic structure, it is preferable that it becomes possible to satisfy the above conditional formula due to a configuration to provide at least one basic structure. For example, in the third basic structure, by a configuration that the value of the above x is set to 10, the value of y is set to 6 and the value of z is set to 5, it becomes possible to satisfy the above conditional formula (1) or (1′).

Next, in the case that an optical element having an optical path difference providing structure in which the first basic structure, the second basic structure and the third basic structure are superimposed is a single optical lens consisting of a sing lens made of a plastic, preferable embodiments will be explained hereafter.

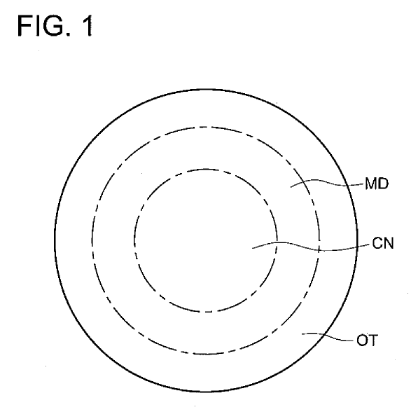

At least one optical surface of the objective lens comprises a central area and a peripheral area around the central area. More preferably, at least one optical surface of the objective lens further includes a most peripheral area around the peripheral area. By providing the most peripheral area, it allows to more appropriately record and/or reproduce information for the optical disk using the high NA. The central area preferably is an area having the optical axis of the objective lens, however, it may also be the area not including the optical axis. It is preferable that the central area, peripheral area, and most peripheral area are provided on the same optical surface. As shown in FIG. 1, it is preferable that the central area CN, peripheral area MD, most peripheral area OT are provided on the same optical surface concentrically around the optical axis. Further, the central area of the objective lens is provided with the first optical path difference providing structure which is the optical path difference providing structure of the present invention in which the first basic structure, the second basic structure and the third basic structure are superimposed.

The peripheral area is provided with the second optical path difference providing structure. The second optical path difference providing structure may be a structure in which three basic structures are superimposed, a structure in which two basic structures are superimposed or a structure composed of a single basic structure. When the most peripheral area is provided, the most peripheral area may be a refractive surface, or the third optical path difference providing structure may be provided in the most peripheral area. The third basic structure may be a structure in which three basic structures are superimposed, a structure in which two basic structures are superimposed or a structure composed of a single basic structure. It is preferable that each of the central area, peripheral area, most peripheral area adjoins to each other, however, there may be a slight gap between adjoining areas.

The area provided with the first optical path difference providing structure is preferably 70% or more of the area of the central area on the objective lens. It is more preferably 90% or more of the area of the central area. The first optical path difference providing structure is furthermore preferably provided on the entire surface of the central area. The area provided with the second optical path difference providing structure is preferably 70% or more of the peripheral area on the objective lens. It is more preferably 90% or more of the area of the peripheral area. The second optical path difference providing structure is further more preferably provided on the entire surface of the peripheral area. The area provided with the third optical path difference providing structure is 70% or more of the area of the most peripheral area on the objective lens. It is more preferably 90% or more of the area of the most peripheral area. The third optical path difference providing structure is more preferably provided on the entire surface of the most peripheral area.

Further, the first optical path difference providing structure provided in the central area of the objective lens and the second optical path difference providing structure provided in the peripheral area of the objective lens may be provided on the different optical surface of the objective lens. However, it is preferable that the first and second optical path difference providing structures are provided on the same optical surface. By providing them on the same optical surface, it reduces the decentering error at the time of the manufacture, which is preferable. Further, it is preferable that the first optical path difference providing structure and the second optical path difference providing structure are provided on the surface on the light source side of the objective lens, rather than the surface on the optical disk side of the objective lens.

The objective lens converges the first light flux, the second light flux, and the third light flux each passing through the central area of the objective lens provided with the first optical path difference providing structure so as to form a converged light spot for each light flux. Preferably, the objective lens converges the first light flux passing through the central area of the objective lens provided with the first optical path difference providing structure onto the information recording surface of the first optical disk so that information can be recorded and/or reproduced for the first optical disk. Preferably, the objective lens converges the second light flux passing the central area of the objective lens provided with the first optical path difference providing structure onto the information recording surface of the second optical disk, so that information can be recorded and/or reproduced for the second optical disk. Preferably, the objective lens converges the third light flux passing the central area of the objective lens provided with the first optical path difference providing structure onto the information recording surface of the third optical disk, so that information can be recorded and/or reproduced for the third optical disk. Further, when the thickness t1 of the protective substrate of the first optical disk and the thickness t2 of the protective substrate of the second optical disk are different, the first optical path difference providing structure preferably corrects the spherical aberration caused due to the difference between the thickness t1 of the protective substrate of the first optical disk and the thickness t2 of the protective substrate of the second optical disk and/or the spherical aberration caused due to the difference of the wavelength of the first light flux and the second light flux, for the first light flux and the second light flux passing through the first optical path difference providing structure. Furthermore, the first optical path difference providing structure preferably corrects the spherical aberration caused due to the difference between the thickness t1 of the protective substrate of the first optical disk and the thickness t3 of the protective substrate of the third optical disk and/or the spherical aberration caused due to the difference of the wavelength of the first light flux and the third light flux, for the first light flux and the third light flux having passed through the first optical path difference providing structure.

Further, the third light flux having passed through the first optical path difference providing structure of the objective lens forms a first best focus in which a spot formed by the third light flux becomes the smallest diameter, and a second best focus in which a spot formed by the third light flux becomes the second smallest diameter. Here, the best focus used herein means a point where the beam waist is minimized within the predetermined defocus range. That is, the matter that the third light flux forms the first best focus and the second best focus means that the third light flux has at least two points at where the beam waist is minimized within the predetermined defocus range. Here, the first best focus is preferably formed by diffracted light rays with the maximum amount of light in the third light flux having passed through the first optical path difference providing structure. The second best focus is preferably formed by diffracted light rays with the second maximum amount of light in the third light flux having passed through the first optical path difference providing structure. When the difference between the diffraction efficiency of the diffracted light rays forming the first best focus and the diffraction efficiency of the diffracted light rays forming the second best focus, is 20% or less, the effect of the present invention becomes more noticeable.

Here, it is preferable that a spot formed by the third light flux in the first best focus is used for recording and/or reproducing information for the third optical disk, and that a spot formed by the third light flux in the second best focus is not used for recording and/or reproducing information for the third optical disk. However, it does not means to deny the embodiment that a spot formed by the third light flux in the first best focus is not used for recording and/or reproducing information for the third optical disk, and that a spot formed by the third light flux in the second best focus is used for recording and/or reproducing information for the third optical disk. Here, when the first optical path difference providing structure is provided on the surface on the light source side of the objective lens, the second best focus is preferably nearer to the objective lens than the first best focus.

Further, the first best focus and the second best focus satisfy the following conditional formula.

0.05≦L/f≦0.35

In the formula, f (mm) represents the focal length of the objective lens for the third light flux which passes through the first optical path difference providing structure and forms the first best focus, and L (mm) represents the distance between the first best focus and the second best focus.

Here, it is more preferable to satisfy the following conditional formula.

0.10≦L/f≦0.21

Further, it is preferable that L is 0.18 mm or more and 0.63 mm or less. Furthermore, it is preferable that f is 1.8 mm or more and is 3.0 mm or less.

The above structure makes it possible to prevent the unnecessary light being not used for recording and/or reproducing information for the third optical disk from providing a bad influence to a light receiving element for a tracking operation, and to maintain the excellent tracking characteristics when information is recorded and/or reproduced for the third optical disk.

Further, the objective lens converges the first light flux and the second light flux each passing through the peripheral area of the objective lens provided with the second optical path difference providing structure so as to form a converged light spot for each light flux. Preferably, the objective lens converges the first light flux passing through the peripheral area of the objective lens provided with the second optical path difference providing structure onto the information recording surface of the first optical disk so that information can be recorded and/or reproduced for the first optical disk. Preferably, the objective lens converges the second light flux passing through the peripheral area of the objective lens provided with the second optical path difference providing structure onto the information recording surface of the second optical disk so that information can be recorded and/or reproduced for the second optical disk. Further, when the thickness t1 of the protective substrate of the first optical disk and the thickness t2 of the protective substrate of the second optical disk are different, the second optical path difference providing structure preferably corrects the spherical aberration caused due to the difference between the thickness t1 of the protective substrate of the first optical disk and the thickness t2 of the protective substrate of the second optical disk, and/or the spherical aberration caused due to the difference of the wavelength of the first light flux and the second light flux, for the first flux and the second light flux passing through the second optical path difference providing structure.

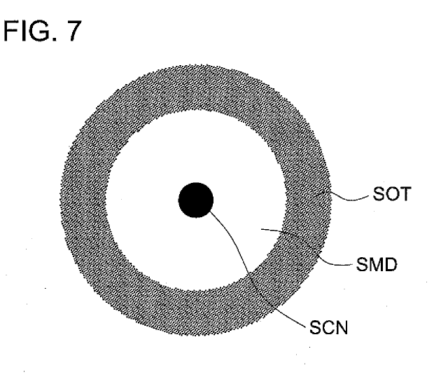

Further, preferable embodiments include the embodiment that the third light flux having passed through the peripheral area is not used for recording and/or reproducing information for the third optical disk. In the embodiment, it is preferable that the third light flux having passed through the peripheral area does not contribute to forming a converged light spot on the information recording surface of the third optical disk. In other words, it is preferable that the third light flux having passed through the peripheral area provided with the second optical path difference providing structure of the objective lens forms flare on the information recording surface of the third optical disk. As shown in FIG. 7, a spot formed on an information recording surface of the third optical disk by the third light flux having passed through the objective lens, comprises a central spot portion SCN having a high light density, an intermediate spot portion SMD having a light density lower than that of the central spot portion and a peripheral spot portion SOT having a light density higher than that of the intermediate spot portion and lower than that of the central spot portion in the order from the optical axis side (or the central part of the spot) to the outside of the spot. The central spot portion is used for recording and/or reproducing information for an optical disk, and the intermediate spot portion and the peripheral spot portion are not used for recording and/or reproducing information for an optical disk. In the above description, this peripheral spot portion is called flare. That is, the third light flux having passed through the second optical path difference providing structure provided in the peripheral area of the objective lens, forms a peripheral spot portion on the information recording surface of the third optical disk. Here, it is preferable that a converged light spot or a spot of the third light flux in the above is a spot in the first best focus. Further, it is preferable that a spot formed on the information recording surface of the second optical disk by the second light flux having passed through the objective lens, comprises a central spot portion, an intermediate spot portion, and a peripheral spot portion.

Further, it is preferable that the second optical path difference providing structure corrects the spherochromatism (chromatic spherical aberration) caused due to the slightly fluctuating wavelength of the first light source or the second light source. The slight fluctuation of the wavelength means the fluctuation within ±10 nm. For example, when the first light flux changes by ±5 nm from the wavelength λ1, it is preferable that the second optical path difference providing structure corrects the fluctuation of the spherical aberration of the first light flux having passed through the peripheral area and the amount of the fluctuation of the spherical aberration on the information recording surface of the first optical disk is 0.010 λ1 rms or more, and is 0.095 λ1 rms or less. Further, when the second light flux changes by ±5 nm from the wavelength λ2, it is preferable that the second optical path difference providing structure corrects the fluctuation of the spherical aberration of the second light flux having passed through the peripheral area and the amount of the fluctuation of the spherical aberration on the information recording surface of the second optical disk is 0.002×2 rms or more, and is 0.03 λ2 rms or less. Therefore, the aberration due to the fluctuation of the wavelength by the manufacturing error of the wavelength of the laser diode which is a light source, or the individual difference of the laser diode can be corrected.

When the objective lens comprises the most peripheral area, the objective lens converges the first light flux passing through the most peripheral area of the objective lens onto the information recording surface of the first optical disk so that information can be recorded and/or reproduced for the first optical disk. Further, it is preferable to correct the spherical aberration in the first light flux having passed through the most peripheral area, when recording and/or reproducing information for the first optical disk is conducted.

Further, preferable embodiments include embodiments that the second light flux having passed through the most peripheral area is not used for recording and/or reproducing information for the second optical disk, and that the third light flux having passed through the most peripheral area is not used for recording and/or reproducing information for the third optical disk. In the embodiment, it is preferable that the second light flux and the third light flux each having passed through the most peripheral area do not contribute to forming the converged light spots on respective information recording surface of the second optical disk and the third optical disk. That is, when the objective lens comprises the most peripheral area, the third light flux passing through the most peripheral area of the objective lens preferably forms flare on the information recording surface of the third optical disk. In other words, the third light flux having passed through the most peripheral area of the objective lens, preferably forms a peripheral spot portion on the information recording surface of the third optical disk. Further, when the objective lens comprises the most peripheral area, the second light flux passing the most peripheral area of the objective lens preferably forms flare on the information recording surface of the second optical disk. In other words, the second light flux which has passed through the most peripheral area on the objective lens, preferably forms a peripheral spot portion on the information recording surface of the second optical disk.

When the most peripheral area comprises the third optical path difference providing structure, the third optical path difference providing structure may correct the sperochromatism (chromatic spherical aberration) caused due to the slightly fluctuated wavelength of the first light source. The slight fluctuation of the wavelength means a fluctuation within ±10 nm. For example, when the first light flux changes by ±5 nm from the wavelength λ1, it is preferable that the third optical path difference providing structure corrects the fluctuation of the spherical aberration of the first light flux having passed through the peripheral area and the amount of the fluctuation of the spherical aberration on the information recording surface of the first optical disk is 0.010 λ1 rms or more, and is 0.095 λ1 rms or less.

Here, although the first optical path difference providing structure is constituted by the superimposition of the first basic structure, the second basic structure and the third basic structure, it is preferable that the first basic structure is an optical path difference providing structure to make an amount of zeroth order diffracted light rays (transmitted rays) of the first light flux having passed through the first basic structure larger than that of any other order diffracted light rays, to make an amount of zeroth order diffracted light rays (transmitted rays) of the second light flux larger than that of any other order diffracted light rays and to make an amount of ± first order diffracted light rays of the third light flux larger than that of any other order diffracted light rays. Further, it is preferable that the second basic structure is an optical path difference providing structure to make an amount of second order diffracted light rays of the first light flux having passed through the second basic structure larger than that of any other order diffracted light rays, to make an amount of first order diffracted light rays of the second light flux larger than that of any other order diffracted light rays and to make an amount of first order diffracted light rays of the third light flux larger than that of any other order diffracted light rays. Further, it is preferable that the third basic structure is an optical path difference providing structure to make an amount of tenth order diffracted light rays of the first light flux having passed through the third basic structure larger than that of any other order diffracted light rays, to make an amount of sixth order diffracted light rays of the second light flux larger than that of any other order diffracted light rays and to make an amount of fifth order diffracted light rays of the third light flux larger than that of any other order diffracted light rays. Namely, it is preferable that r=0, s=0, t=±1, u=2, v=1, w=1, x=10, y=6 and z=5. Here, the third basic structure may be an optical path difference providing structure to make an amount of second order diffracted light rays of the first light flux having passed through the third basic structure larger than that of any other order diffracted light rays, to make an amount of first order diffracted light rays of the second light flux larger than that of any other order diffracted light rays and to make an amount of first order diffracted light rays of the third light flux larger than that of any other order diffracted light rays. In this case, x=2, y=1 and z=1. In this example, the first basic structure and the third basic structure are a compatible structure and the third basic structure is a temperature change compensating structure.

Herein, it may be preferable that the first basic structure is a binary type structure as shown in FIG. 2(e), the second basic structure is a saw tooth type structure as shown in FIGS. 2(a) and 2(b) and the third basic structure is a stairs type structure as shown in FIG. 2(c). Further, the second optical path difference structure is preferably a configuration in which the second basic structure and the fourth basic structure are superimposed. The fourth basic structure is an optical path difference providing structure to make an amount of d^{th} order diffracted light rays of the first light flux having passed through the fourth basic structure larger than that of any other order diffracted light rays, to make an amount of e^{th} order diffracted light rays of the second light flux larger than that of any other order diffracted light rays and to make an amount of f^{th} order diffracted light rays of the third light flux larger than that of any other order diffracted light rays. Here, it may be desirable that u=2, v=1 and w=1. Further, it may be desirable that d=5, e=3 and f=3 or 2, or d=2, e=1 and f=1. The fourth basic structure is preferably a stairs type structure as shown in FIG. 2(c). The second basic structure is a compatible structure and the fourth basic structure is a temperature change compensating structure.

Further, in the case that the objective lens is a plastic lens, it may desirable that the objective lens has a most periphery area having the third optical path difference structure. In this case, the third optical path difference providing structure is preferably an optical path difference providing structure consisting of only a single one of the fourth basic structure or the fifth basic structure. The fifth basic structure is an optical path difference providing structure to make an amount of a^{th} order diffracted light rays of the first light flux having passed through the fifth basic structure larger than that of any other order diffracted light rays, to make an amount of b^{th} order diffracted light rays of the second light flux larger than that of any other order diffracted light rays and to make an amount of c^{th} order diffracted light rays of the third light flux larger than that of any other order diffracted light rays. Here, “a”, “b” and “c” is an integer except 0 (zero), although the value of “a” is not limited to a specific value, it may be applied with 10, 5, 4 or 2. The fourth basic structure and the fifth basic structure are preferably a stairs type structure as shown in FIG. 2(c). The fourth basic structure and the fifth basic structure are a temperature change compensating structure.

Further, on the entire body of an objective lens, namely, in the case of considering the first optical path difference providing structure, the second optical path difference providing structure and the third optical path difference providing structure in combination, a basic structure of the temperature change compensating structure is as whole preferably a stairs type structure in which the length of an optical path in a cross sectional shape including an optical axis becomes longer as the position of the optical path is separated from the optical axis up to the predetermined height from the optical axis and the length of an optical path becomes shorter as the position of the optical path is separated further from the predetermined height. As another expression, it may be said preferable that as the height from the optical axis becomes larger, it becomes deeper in the direction of the optical axis, and as it exceeds more an optional height, it becomes shallower in the direction of the optical axis. For example, in the above example, in the case that the third basic structure in the first optical path difference providing structure, the fourth basic structure in the second optical path difference providing structure and the fourth basic structure or the fifth basic structure in the third optical path difference providing structure are taken in combination as one structure, it may be said preferable that as the height from the optical axis becomes larger, it becomes deeper in the direction of the optical axis, and as it exceeds more an optional height, it becomes shallower in the direction of the optical axis.

As stated above, in the case that an objective lens is a plastic lens, examples of preferable embodiments include an embodiment that a central area has a configuration in which a temperature change compensating structure and two kinds of compatible structures are superimposed, a peripheral area has a configuration in which a temperature change compensating structure and one kind of compatible structure are superimposed, and a most peripheral area has a configuration consisting of a temperature change compensating structure.

NA1 represents the image side numerical aperture of the objective lens necessary for reproducing and/or recording information for the first optical disk. NA2 (NA1>NA2) represents that the image side numerical aperture of the objective lens necessary for reproducing and/or recording for the information to the second optical disk. NA3 (NA2>NA3) represents that the image side numerical aperture of the objective lens necessary for reproducing and/or recording information for the third optical disk.

It is preferable that the border between the central area and the peripheral area in the objective lens is formed in a portion corresponding to the range of 0.9·NA3 or more and 1.2·NA3 or less (more preferably, 0.95·NA3 or more and 1.15·NA3 or less). More preferably, the border between the central area and the peripheral area of the objective lens is formed in a portion corresponding to NA3. Further, it is preferable that the border between the peripheral area and the most peripheral area of the objective lens is formed in a portion corresponding to the range of 0.9·NA2 or more and 1.2·NA2 or less (more preferably 0.95·NA2 or more and 1.15·NA2 or less). More preferably, the border between the peripheral area and the most peripheral area of the objective lens is formed in a portion corresponding to NA2. It is preferable that the border of the outside of the most peripheral area of the objective lens is formed in a portion corresponding to the range of 0.9·NA1 or more and 1.2·NA1 or less (more preferably, 0.95·NA1 or more and 1.15·NA1 or less). More preferably, the border of the outside of the most peripheral area of the objective lens is formed in a portion corresponding to NAT.

When the third light flux having passed through the objective lens is converged on the information recording surface of the third optical disk, it is preferable that the spherical aberration has at least one discontinuous portion. In that case, it is preferable that the discontinuous portion exists in the range of 0.9·NA3 or more and 1.2·NA3 or less (more preferably, 0.95·NA3 or more and 1.15·NA3 or less). Further, also when the second light flux having passed through the objective lens is converged on the information recording surface of the second optical disk, it is preferable that the spherical aberration has at least one discontinuous portion. In that case, it is preferable that the discontinuous portion exists in the range of 0.9·NA2 or more and being 1.2·NA2 or less (more preferably, 0.95·NA2 or more and being 1.1·NA2 or less).

Further, when the spherical aberration is continuous and does not have the discontinuous portion, and when the third light flux having passed through the objective lens is converged on the information recording surface of the third optical disk, it is preferable that the absolute value of the longitudinal spherical aberration in NA2 is 0.03 μm or more, and the absolute value of the longitudinal spherical aberration in NA3 is 0.02 μm or less. More preferably, the absolute value of the longitudinal spherical aberration in NA2 is 0.08 μm or more, and the absolute value of the longitudinal spherical aberration in NA3 is 0.01 μm or less. Further, when the second light flux having passed through the objective lens is converged on the information recording surface of the second optical disk, it is preferable that the absolute value of the vertical spherical aberration in NA1 is 0.03 μm or more, and the absolute value of the vertical spherical aberration in NA2 is 0.005 μm or less.

Further, because the diffraction efficiency depends on the depth of the ring shaped zone in the diffractive structure, the diffraction efficiency of the central area for each wavelength can be appropriately set corresponding to the usage of the optical pickup apparatus. For example, in the case of the optical pickup apparatus to conduct recording and reproducing information for the first optical disk and to conduct only reproducing information for the second and the third optical disks, it is preferable that the diffraction efficiency of the central area and/or the peripheral area is determined with the primary weight placed on the first light flux. On the other hand, in the case of the optical pickup apparatus to conduct only reproducing information for the first optical disks and to conduct recording and reproducing information for the second and third optical disks, it is preferable that the diffraction efficiency of the central area is determined with the primary weight placed on the second and third light fluxes and the diffraction efficiency of the peripheral area is determined with the primary weight placed on the second light flux.

In any case, when the following conditional formula is satisfied, it becomes possible to secure a diffraction efficiency of the first light flux calculated by the area-weighted mean to be high.

η11≦η21

In the formula, η11 represents the diffraction efficiency of the first light flux in the central area, η21 represents the diffraction efficiency of the first light flux in the peripheral area. Here, when the diffraction efficiency of the central area is determined with the primary weight placed on the second and the third wavelengths, the diffraction efficiency of the first light flux in the central area is decreased. However, in the case where the numerical aperture of the first optical disk is larger than the numerical aperture of the third optical disk, when the diffraction efficiency is considered on the whole effective diameter of the first light flux, the diffraction efficiency decreased in the central area does not provide so large influence.

Here, the diffraction efficiency in the present specification can be defined as follows.

(1) The transmittance of an objective lens which has the same focal length, the same lens thickness and the same numerical aperture, is made of the same material and is not provided with the first and the second optical path difference providing structure is measured separately for each of the central area and the peripheral area. At this time, the transmittance of the central area is measured under the condition that a light flux entering into the peripheral area is blocked off, and the transmittance of the peripheral area is measured under the condition that a light flux entering into the central area is blocked off.
(2) The transmittance of another objective lens which has the same focal length, the same lens thickness and the same numerical aperture, is made of the same material and is provided with the first and the second optical path difference providing structure is measured separately for each of the central area and the peripheral area.
(3) The results of (2) are divided by the results of (1) and the calculation results are made the diffraction efficiency of the respective areas.

Further, the light utilization efficiency of any two light fluxes of the first light flux, the second light flux and the third light flux may be 80% or more, and the light utilization efficiency of the remaining one light flux may be 30% or more and 80% or less. The light utilization efficiency of the remaining one light flux may also be 40% or more and 70% or less. In this case, it is preferable that a light flux having the light utilization efficiency of 30% or more and 80% or less (or 40% or more and 70% or less) is the third light flux.

Here, the light utilization efficiency described in this specification is calculated as follows. When A represents an amount of light in an Airy disk of a converged light spot formed on an information recording surface of an optical disk by an objective lens in which the first optical path difference providing structure and the second optical path difference providing structure are formed (the third optical path difference providing structure may be formed) and B represents an amount of light in an Airy disk of a converged light spot formed on an information recording surface of an optical disk by an objective lens which is formed with the same material and has the same focal length, the same axial thickness, the same numerical aperture, the same wave front aberration and in which the first optical path difference providing structure and the second optical path difference providing structure are not formed, the light utilization efficiency is calculated by (A/B). Here, the above described Airy disk is a circle having a radius of r′ the center positioned at the optical axis of the converged light spot. The radius r′ is expressed by r′=0.61·λ/NA.

Further, in the case that a difference in an amount of light between diffracted light rays with a diffraction order having the largest amount of light and diffracted light rays with another diffraction order having the second largest amount of light in the third light flux having passed through the first optical path difference providing structure, that is, a difference in an amount of light between diffracted light rays forming the first best focus and diffracted light rays forming the second best focus, is 0% or more and 20% or less, it is difficult to maintain the tracking characteristic, in particular in the third optical disk, in the good condition. However, the present invention makes it possible to maintain the tracking characteristics in the good condition under the above-described situation.

Each of the first light flux, the second light flux and the third light flux may enters into the objective lens as a parallel light flux, or may also enter into the objective lens as a divergent light flux or a convergent light flux. Preferably, when the first light flux and the second light flux enter into the objective lens, the magnification m1 and m2 of incident light fluxes into the objective lens satisfies the following conditional formula.

−0.02<m1<0.02

−0.02<m2<0.02

Further, when the third light flux enters into the objective lens as a parallel light flux or almost parallel light flux, it is preferable that when the third light flux enters into the objective lens, the magnification m3 of an incident light flux into the objective lens satisfies the following conditional formula. When the third light flux is a parallel light flux, soma problem may be easily caused in the tracking operation. However, even when the third light flux is a parallel light flux, the present invention makes it possible to obtain the good tracking characteristics, and recording and/or reproducing information can be adequately conducted for three different optical disks.

−0.02<m3<0.02

On the one hand, when the third light flux enters into the objective lens as a divergent light flux, it is preferable that when the third light flux enters into the objective lens, the magnification m3 of an incident light flux into the objective lens satisfies the following conditional formula.

−0.10<m3<0.00

When the wavelength of a light flux emitted from each light source (in particular, the wavelength of the first light flux emitted from the first light source) changes by ±5 nm, it is preferable that the amount of change of wavefront aberration on an information recording surface of each optical disk (in particular, the first optical disk) is 0.010 λ1 rms or more and 0.095 λ1 rms or less. Further, when environmental temperature is changed by ±30° C. from a design standard temperature, it is preferable to correct the spherical aberration of the first light flux such that the amount of change of wavefront aberration on an information recording surface of the first optical disk is 0.010 λ1 rms or more and 0.095 λ1 rms or less.

Further, it is preferable that when the third optical disk is used, the working distance (WD) of the objective lens is 0.20 mm or more and is 1.5 mm or less. It is more preferably 0.3 mm or more and 1.0 mm or less. Next, it is preferable that when the second optical disk is used, the working distance (WD) of the objective lens is 0.4 mm or more and is 0.7 mm or less. It is preferable that when the first optical disk is used, the working distance (WD) of the objective lens is 0.4 mm or more and is 0.9 mm or less (when t1≦t2, it is preferably 0.6 mm or more and is 0.9 mm or less).

It is preferable that the entrance pupil diameter of the objective lens is 2.8 mm or more and is 4.5 mm or less when the first optical disk is used.

The optical information recording and reproducing apparatus according to the present invention, has the optical disk drive apparatus having the above described optical pickup apparatus.

Herein, the optical disk drive apparatus installed in the optical information recording and reproducing apparatus will be described. In the optical disk drive apparatus, there are a type in which only a tray capable of holding an optical disk can be taken out to the outside from the main body of the optical information recording and reproducing apparatus in which an optical pickup apparatus is housed; and another type in which the main body of the optical disk drive apparatus accommodating an optical pickup apparatus can be taken out to the outside.

The optical information recording and reproducing apparatus employing one of the above described types, is generally provided with the following structural members: an optical pickup apparatus housed in a housing; a drive source of the optical pickup apparatus such as seek-motor to shift an optical pickup apparatus with the housing toward an inner periphery or outer periphery of an optical disk; conveying means having a guide rail for guiding the optical pickup apparatus toward the inner periphery or outer periphery of the optical disk; and a spindle motor for rotating an optical disk. However, it is to be understood that various changes and modifications will be made to those skilled in the art.

In addition to the above structural members, the optical information recording and reproducing apparatus employing the former type is provided with a tray which can hold the optical disk with the optical disk being mounted thereon, and a loading mechanism for slidably moving the tray. The optical information recording and reproducing apparatus employing the latter system does not include the tray and loading mechanism, and it is preferable that each component member is provided in the drawer corresponding to chassis which can be taken out outside.

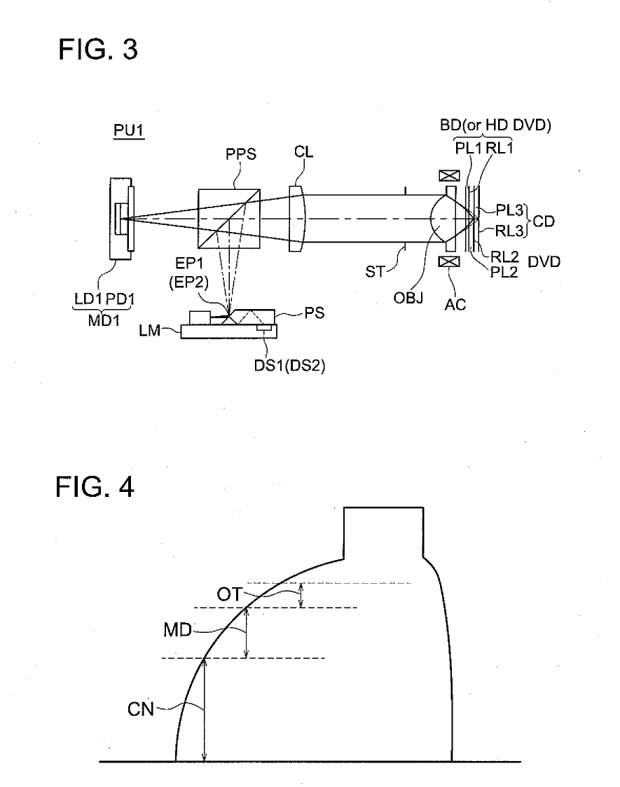

Hereafter, an embodiment in the case that an optical element comprising an optical path difference providing structure of the present invention in which the first basic structure, the second basic structure and the third basic structure are superimposed is an objective lens being a single lens made of a plastic, will be explained with reference to drawings. FIG. 3 is a view schematically showing optical pickup apparatus PU1 of the present embodiment capable of recording and/or reproducing information adequately for BD, DVD and CD which are different optical disks. The optical pickup apparatus PU1 can be mounted in the optical information recording and reproducing apparatus. Herein, the first optical disk is BD, the second optical disk is DVD, and the third optical disk is CD. Here, the present invention is not limited to the present embodiment.

The optical pickup apparatus PU1 comprises an objective lens OBJ; an aperture stop ST; a collimator lens CL; a polarizing dichroic prism PPS; a first semiconductor laser LD1 (the first light source) which emits a laser light flux with a wavelength of 405 nm (the first light flux) when recording/reproducing information for BD; and a first light receiving element PD1 which receives the reflection light from an information recording surface RL1 of BD; and a laser module LM.

Further, the laser module LM comprises a second semiconductor laser EP1 (the second light source) which emits a laser light flux with a wavelength of 658 nm (the second light flux) when recording and/or reproducing information for DVD; a third semiconductor laser EP2 (the third light source) emitting a laser light flux with a wavelength of 785 nm (the third light flux) when recording and/or reproducing information for CD; a second light receiving element DS1 which receives the reflection light flux from the information recording surface RL2 of DVD; a third light receiving element DS2 which receives the reflection light flux from the information recording surface RL3 of CD; and a prism PS.

As shown in FIG. 1 and FIG. 4, the objective lens OBJ includes a central area CN including the optical axis; a peripheral area MD arranged around the central area; and a most peripheral area OT further arranged around the peripheral area, which are formed concentrically around the optical axis in the aspheric optical surface of the light source side of the objective lens. Here, the area ratio of the central area, peripheral area, most peripheral area shown in FIG. 1 and FIG. 4 is not expressed exactly. The first optical path difference providing structure is provided on the entire surface of the central area CN and the second optical path difference providing structure is provided on the entire surface of the peripheral area MD. Further, the third optical path difference providing structure is provided on the most peripheral area.

A blue-violet semiconductor laser diode LD1 emits a first light flux (λ1=405 nm) which is a divergent light flux. The divergent light flux passes through the polarizing dichroic prism PPS, and is converted into a parallel light flux by the collimator lens CL, The parallel light flux is converted from straight line polarized light into circular polarized light by the ¼ wavelength plate which is not shown. The diameter of the converted light flux is regulated by the aperture stop ST, and the objective lens OBJ forms the regulated light flux into a spot on the information recording surface RL1 of BD through the protective substrate with thickness of 0.0875 mm.

The light flux on the information recording surface RL1 is reflected and modulated by the information pit on the information recording surface RL1. The reflected light flux passes through the objective lens OBJ, the aperture stop ST again, and is converted from circular polarized light into straight line polarized light by the ¼ wavelength plate which is not shown. Then, the collimator lens CL convert the light flux into a convergent light flux. The convergent light flux passes through the polarizing dichroic prism PPS and is converged on the light receiving surface of the first light receiving element PD1. Then, information recorded in BD can be read based on the output signal of the first light receiving element PD1, by focusing or tracking the objective lens OBJ using biaxial actuator AC.

Red semiconductor laser EP1 emits a second light flux (λ2=658 nm) which is a divergent light flux. The divergent light flux is reflected by the prism PS and is further reflected by the polarizing dichroic prism PPS. Collimator lens CL collimate the reflected light flux and the parallel light flux is converted from straight line polarized light into circular polarized light by the ¼ wavelength plate which is not shown. The converted light flux enters into the objective lens OBJ. Herein, the incident light flux is converged by the central area and the peripheral area of the objective lens OBJ (the light flux having passed through the most peripheral area is made into a flare, and forms the peripheral spot portion). The converged light flux becomes a spot on the information recording surface RL2 of DVD through the protective substrate PL2 with a thickness of 0.6 mm, and forms the central spot portion.

The light flux on the information recording surface RL2 is reflected and modulated by the information pit on the information recording surface RL2. The reflection light flux passes through the objective lens OBJ and the aperture stop ST again, and is converted from circular polarized light into straight line polarized light by the ¼ wavelength plate which is not shown. Then, Collimator lens CL converts the light flux into a convergent light flux, the convergent light flux is reflected by the polarizing dichroic prism PPS, then, is reflected two times in the prism, and converged on the second light receiving element DS1. Then, the information recorded in DVD can be read by using the output signal of the second light receiving element DS1.

Infrared semiconductor laser EP2 emits the third light flux (λ3=785 nm) which is a divergent light flux. The divergent light flux is reflected by prism PS, and further reflected by the polarizing dichroic prism PPS. Collimator lens CL collimate the reflected light flux and the parallel light flux is converted from straight line polarized light into circular polarized light by the ¼ wavelength plate which is not shown. The converted light flux enters into the objective lens OJT. Herein, the incident light flux is converged by the central area of the objective lens OBJ (the light flux having passed through the peripheral area and the most peripheral area is made into a flare, and forms the peripheral spot portion). The converged light flux becomes a spot on the information recording surface RL3 of CD through the protective substrate PL3 with thickness of 1.2 mm, and forms the central spot portion.

The light flux on the information recording surface RL3 is reflected and modulated by the information pit on the information recording surface RL3. The reflection light flux passes through the objective lens OBJ and the aperture stop ST again, and is converted from circular polarized light into straight line polarized light by the ¼ wavelength plate which is not shown. Then, the collimator lens CL converts the light flux into a convergent light flux, the convergent light flux is reflected by the polarizing dichroic prism PPS, then, is further reflected two times in the prism. The reflected light flux is converged on the third light receiving element DS2. Then, information recorded in CD can be read by using output signal of the third light receiving element DS2.

When the first light flux emitted from the blue-violet semiconductor laser LD1 enters into the objective lens OBJ as a parallel light flux, the first optical path difference providing structure of the central area, the second optical path difference providing structure of the peripheral area and the third optical path difference providing structure of the most peripheral area adequately corrects the spherical aberration of the first light flux. Therefore, information can be recorded and/or reproduced adequately for BD having a protective substrate with a thickness t1. Further, when the second light flux emitted from the red semiconductor laser EP1 enters into the objective lens OBJ as a parallel light flux, the first optical path difference providing structure of the central area, the second optical path difference providing structure of the peripheral area adequately corrects the spherical aberration of the second light flux generated due to the thickness difference between the protective substrates of BD and DVD and the wavelength difference between the first light flux and the second light flux, and the third optical path difference providing structure of the most peripheral area makes the second light flux the flare on the information recording surface of DVD. Therefore, information can be recorded and/or reproduced adequately for DVD having a protective substrate with thickness of t2. Further, when the third light flux emitted from the infrared semiconductor laser EP2 enters into the objective lens OBJ as the parallel light flux, the first optical path difference providing structure of the central area adequately corrects the spherical aberration of the third light flux generated due to the thickness difference between the protective substrates of BD and CD and the wavelength difference between the first light flux and the third light flux, and the second optical path difference providing structure of the peripheral area and the third optical path difference providing structure of the most peripheral area make the third light flux the flare on the information recording surface of CD. Therefore, information can be recorded and/or reproduced adequately for CD having a protective substrate with thickness of t3. Further, the first optical path difference providing structure on the central area separates a converged light spot of a necessary light of the third light flux which is used for recording and reproducing information, and a converged light spot of an unnecessary light of the third light flux by the adequate distance. Thereby, the first optical path difference providing structure also makes the tracking characteristic good when CD is used. Additionally, the second optical path difference providing structure on the peripheral area can correct the spherochromatism (chromatic spherical aberration) for the first light flux and the second light flux when the wavelength is deviated from the reference wavelength due to the reason such as the manufacturing error of the laser diode.

### EXAMPLE

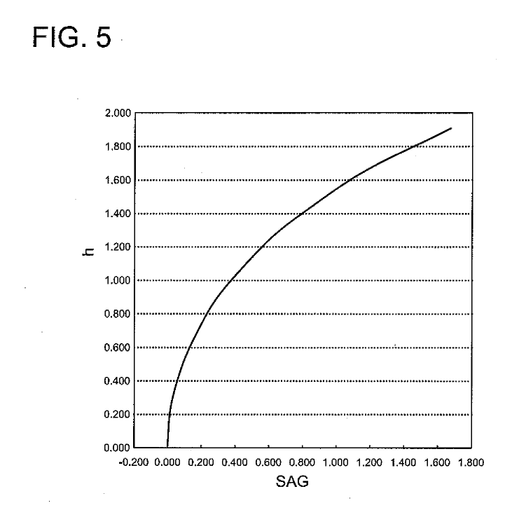

The objective lens is a plastic lens being a single lens. The first optical path difference providing structure is formed on the entire surface of the central area CN of an optical surface of the objective lens. The second optical path difference providing structure is formed on the entire surface of the peripheral area MD of the optical surface. The third optical path difference providing structure is formed on the entire surface of the most peripheral area OT of the optical surface. The cross sectional shape of the objective lens is shaped into one shown in FIG. 5.

The first optical path difference providing structure is a structure in which the first basic structure, the second basic structure and the third basic structure are superimposed and is shaped in a configuration in which two kinds of saw tooth-shaped diffractive structures and a binary structure are superimposed.

The first basic structure being a binary structure is a so-called wavelength selecting diffractive structure and is designed so as to make the amount of zeroth order diffracted light rays (transmitted light rays) of the first light flux larger than that of any other-order diffracted light rays, to make the amount of zeroth order diffracted light rays (transmitted light rays) of the second light flux larger than that of any other-order diffracted light rays, and to make the amount of first order diffracted light rays of the third light flux larger than that of any other-order diffracted light rays (including zeroth order, that is, transmitted light rays).

The second basic structure is a saw tooth type diffractive structure and is designed so as to make the amount of second order diffracted light rays of the first light flux larger than that of any other-order diffracted light rays (including zeroth order, that is, transmitted light rays), to make the amount of first order diffracted light rays of the second light flux larger than that of any other-order diffracted light rays (including zeroth order, that is, transmitted light rays), and to make the amount of first order diffracted light rays of the third light flux larger than that of any other-order diffracted light rays (including zeroth order, that is, transmitted light rays).

The third basic structure is a saw tooth type diffractive structure and is designed so as to make the amount of tenth order diffracted light rays of the first light flux larger than that of any other-order diffracted light rays (including zeroth order, that is, transmitted light rays), to make the amount of sixth order diffracted light rays of the second light flux larger than that of any other-order diffracted light rays (including zeroth order, that is, transmitted light rays), and to make the amount of fifth order diffracted light rays of the third light flux larger than that of any other-order diffracted light rays (including zeroth order, that is, transmitted light rays).

Here, the above first basic structure is structured such that the width of a binary shape becomes gradually smaller as the position on the shape becomes distant from the optical axis. In the second basic structure, the optical axis side area of the central area is structured such a blaze type that steps face toward the optical axis side, the periphery side area of the central area is structured such a blaze type that steps face toward the direction reverse to the optical axis side, and between them, there is provided a transient area necessary for changing the direction of steps of the saw tooth type structure. The size of a triangular shape in a blaze type shape becomes gradually larger or smaller as the position on the shape becomes distant from the optical axis. Here, the size of the third basic structure is not fixed and may change.

The second optical path different providing structure is structured such that the second basic structure and the fourth basic structure are superimposed and is shaped such that a saw tooth type diffractive structure and a rougher saw tooth type diffractive structure are superimposed.

The second basic structure is a saw tooth type diffractive structure and is designed so as to make the amount of second order diffracted light rays of the first light flux larger than that of any other-order diffracted light rays (including zeroth order, that is, transmitted light rays), to make the amount of first order diffracted light rays of the second light flux larger than that of any other-order diffracted light rays (including zeroth order, that is, transmitted light rays), and to make the amount of first order diffracted light rays of the third light flux larger than that of any other-order diffracted light rays (including zeroth order, that is, transmitted light rays).

The fourth basic structure is a rougher saw tooth type diffractive structure and is designed so as to make the amount of fifth order diffracted light rays of the first light flux larger than that of any other-order diffracted light rays, to make the amount of third order diffracted light rays of the second light flux larger than that of any other-order diffracted light rays, and to make the amount of third and second order diffracted light rays of the third light flux larger than that of any other-order diffracted light rays (including zeroth order, that is, transmitted light rays).

The third optical path difference providing structure is a structure composed on only the fourth basic structure.

Here, in this embodiment, the first basic structure and the second basic structure are a compatible structure, and the third basic structure and the fourth basic structure are a temperature change compensating structure. Further, in the case that the third basic structure in the first optical path difference providing structure, the fourth basic structure in the second optical path difference providing structure and the fourth basic structure in the third optical path difference providing structure are taken in combination as one structure, as the height from the optical axis becomes larger, it becomes deeper in the direction of the optical axis, and as it exceeds more an optional height, it becomes shallower in the direction of the optical axis.

The lens data of the examples are shown In Tables 1. Hereinafter, the power of 10 will be expressed as by using “E”. For example, 2.5×10⁻³ will be expressed as 2.5E-3.

Each of optical surfaces of the objective lens is formed as an aspherical surface which is symmetric around the optical axis and is defined by the mathematical formula in which the coefficients shown in Tables described later are substituted into Mathematical Formula 1.

$$X ( h ) = \frac{( {h}^{2} / r )}{1 + \sqrt{1 - ( 1 + κ ) {( h / r )}^{2}}} + {\sum }_{i = 0}^{10} {A}_{2 i} {h}^{2 i} \qquad Mathematical Formula 1$$

Here, X(h) is an axis in the optical axis (the progressing direction of light is made positive), K is a conical constant, A₂ᵢ is an aspherical coefficient, h is a height from the optical axis.

Further, an optical path length provided to a light flux of each wavelength by a diffractive structure is defined by the mathematical formula in which the coefficients shown in Tables described later are substituted into the optical path difference function of Mathematical Formula 2.

$$Φ ( h ) = \frac{λ}{{λ}_{B}} \times dor \times {\sum }_{i = 0}^{6} {C}_{2 i} {h}^{2 i} \qquad Mathematical Formula 2$$

Here, λ is the wavelength of an incident light flux, λ_{B} is a design wavelength (a blazed wavelength), dor is a diffraction order, C₂ᵢ is coefficients of the optical path difference function.

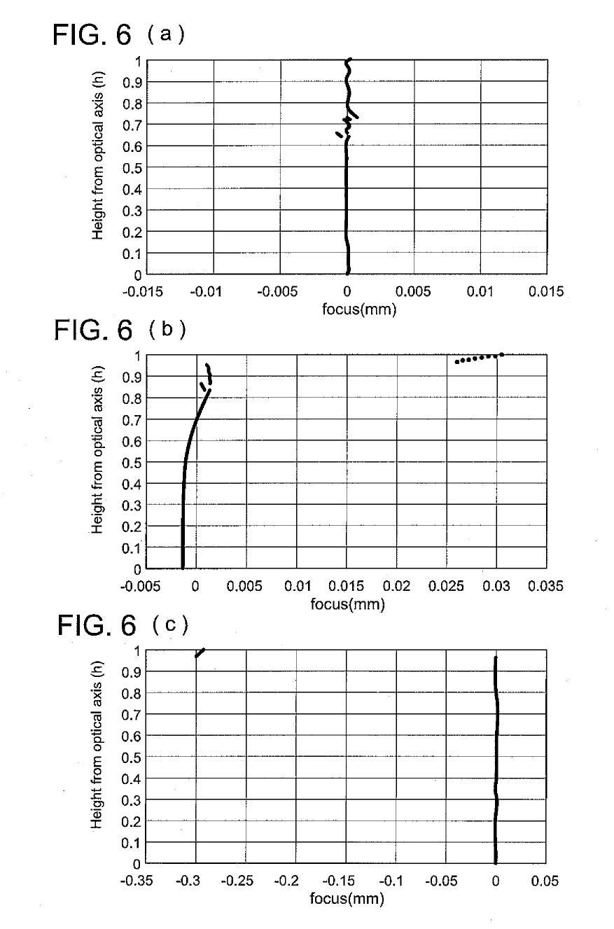

Lens data will be shown in Tables 1 to 4. Further, FIG. 6 represents a longitudinal aspherical aberration diagram of the present example. FIG. 6(a), 6(b), and 6(c) show longitudinal spherical aberration diagrams of BD, DVD and CD respectively. In BD shown in FIG. 6(a), the numeral 1.0 of the vertical axis of the longitudinal spherical aberration diagrams represents NA 0.85, or a diameter of 3.74 mm. In DVD shown in FIG. 6(b), the numeral 1.0 represents a value slightly larger than NA 0.60, or a value slightly larger than a diameter of 2.7 mm. In CD shown in FIG. 6(c), the numeral 1.0 represents a value slightly larger than NA 0.45, or a value slightly larger than a diameter of 2.37 mm. Here, L is 0.60 mm in Example. Accordingly, it provides L/f=0.60/2.53=0.237. Further, in the present example, since ΔSA=0.056, it provides ΔSA/t1=0.056/2.2=0.0254.

### Example of a Diffractive Lens being a Single Lens

Lens Data

| Focal length of | | f₁ = 2.20 mm | | f₂ = 2.28 mm | | f₃ = 2.42 mm | |
|---|---|---|---|---|---|---|---|
| the objective lens | | | | | | | |
| Numerical aperture | | NA1: 0.85 | | NA2: 0.60 | | NA3: 0.45 | |
| Magnification | | m1: 0 | | m2: 0 | | m3: 0 | |
| The i-th | | di(405 | ni(405 | di(658 | ni(658 | di(785 | ni(785 |
| surface | ri | nm) | nm) | nm) | nm) | nm) | nm) |
| 0 | | ∞ | | ∞ | | ∞ | |
| 1(Stop | | 0.0 | | 0.0 | | 0.0 | |
| diameter) | | (φ3.74 | | (φ2.70 | | (φ2.37 | |
| | | mm) | | mm) | | mm) | |
| 2 | 1.5656 | 2.680 | 1.561 | 2.680 | 1.540 | 2.680 | 1.536 |
| 2-1 | 1.5626 | | | | | | |
| 2-2 | 1.5595 | | | | | | |
| 2-3 | 1.5570 | | | | | | |
| 2-4 | 1.5661 | | | | | | |
| 2-5 | 1.5633 | | | | | | |
| 2-6 | 1.5643 | | | | | | |
| 2-7 | 1.5657 | | | | | | |
| 2-8 | 1.5656 | | | | | | |
| 2-9 | 1.53232 | | | | | | |
| 3 | −2.8740 | 0.67 | | 0.43 | | 0.41 | |
| 4 | ∞ | 0.0875 | 1.620 | 0.600 | 1.577 | 1.200 | 1.571 |
| 5 | ∞ | | | | | | |

φrepresents diameter

TABLE 2

| | | Surface No. | | | |
|---|---|---|---|---|---|
| | | 2 | 2-1 | 2-2 | 2-3 |
| | | Area | | | |
| | | h ≦ 0.3982 | 0.3982 ≦ h ≦ 0.6392 | 0.6392 ≦ h ≦ 0.9173 | 0.9173 ≦ h ≦ 1.2020 |
| Aspheric | κ | −0.545763E+00 | −0.544149E+00 | −0.543545E+00 | −0.540372E+00 |
| surface | A0 | 0.000000E+00 | 0.723148E−02 | 0.144639E−01 | 0.217471E−01 |
| coefficient | A4 | 0.173456E−01 | 0.173456E−01 | 0.173456E−01 | 0.173456E−01 |
| | A6 | 0.161268E−02 | 0.161268E−02 | 0.161268E−02 | 0.161268E−02 |
| | A8 | 0.227272E−02 | 0.227272E−02 | 0.227272E−02 | 0.227272E−02 |
| | A10 | −0.176212E−02 | −0.176212E−02 | −0.176212E−02 | −0.176212E−02 |
| | A12 | 0.832672E−03 | 0.832672E−03 | 0.832672E−03 | 0.832672E−03 |
| | A14 | 0.306247E−03 | 0.306247E−03 | 0.306247E−03 | 0.306247E−03 |
| | A16 | −0.312510E−03 | −0.312510E−03 | −0.312510E−03 | −0.312510E−03 |
| | A18 | 0.779196E−04 | 0.779196E−04 | 0.779196E−04 | 0.779196E−04 |
| | A20 | −0.382183E−05 | −0.382183E−05 | −0.382183E−05 | −0.382183E−05 |
| Optical | Diffraction | 2/1/1 | 2/1/1 | 2/1/1 | 2/1/1 |
| path | order | | | | |
| difference | Design | 395 nm | 395 nm | 395 nm | 395 nm |
| function | wavelength | | | | |
| | B2 | −7.9481E−03 | −7.9481E−03 | −7.9481E−03 | −7.9481E−03 |
| | B4 | 3.1618E−03 | 3.1618E−03 | 3.1618E−03 | 3.1618E−03 |
| | B6 | 2.6104E−04 | 2.6104E−04 | 2.6104E−04 | 2.6104E−04 |
| | B8 | −1.5449E−04 | −1.5449E−04 | −1.5449E−04 | −1.5449E−04 |
| | B10 | 1.3011E−04 | 1.3011E−04 | 1.3011E−04 | 1.3011E−04 |
| Optical | Diffraction | 0/0/1 | 0/0/1 | 0/0/1 | 0/0/1 |
| path | order | | | | |
| difference | Design | 785 nm | 785 nm | 785 nm | 785 nm |
| function | wavelength | | | | |
| | B2 | 3.2600E−02 | 3.2600E−02 | 3.2600E−02 | 3.2600E−02 |
| | B4 | −3.0280E−03 | −3.0280E−03 | −3.0280E−03 | −3.0280E−03 |
| | B6 | 2.4526E−03 | 2.4526E−03 | 2.4526E−03 | 2.4526E−03 |
| | B8 | −1.0989E−03 | −1.0989E−03 | −1.0989E−03 | −1.0989E−03 |
| | B10 | 2.4093E−04 | 2.4093E−04 | 2.4093E−04 | 2.4093E−04 |

TABLE 3

| | | Surface No. | | | |
|---|---|---|---|---|---|
| | | 2-4 | 2-5 | 2-6 | 2-7 |
| | | Area | | | |
| | | 1.2020 ≦ h ≦ 1.2390 | 1.2390 ≦ h ≦ 1.2677 | 1.2677 ≦ h ≦ 1.3121 | 1.3121 ≦ h ≦ 1.3466 |
| Aspheric | κ | −0.523735E+00 | −0.534676E+00 | −0.540742E+00 | −0.536630E+00 |
| surface | A0 | 0.193505E−01 | 0.150921E−01 | 0.113044E−01 | 0.782945E−02 |
| coefficient | A4 | 0.173456E−01 | 0.173485E−01 | 0.175724E−01 | 0.172773E−01 |
| | A6 | 0.161268E−02 | 0.161268E−02 | 0.161268E−02 | 0.161268E−02 |
| | A8 | 0.227272E−02 | 0.227272E−02 | 0.227272E−02 | 0.227272E−02 |
| | A10 | −0.176212E−02 | −0.176212E−02 | −0.176212E−02 | −0.176212E−02 |
| | A12 | 0.832672E−03 | 0.832672E−03 | 0.832672E−03 | 0.832672E−03 |
| | A14 | 0.306247E−03 | 0.306247E−03 | 0.306247E−03 | 0.306247E−03 |
| | A16 | −0.312510E−03 | −0.312510E−03 | −0.312510E−03 | −0.312510E−03 |
| | A18 | 0.779196E−04 | 0.779196E−04 | 0.779196E−04 | 0.779196E−04 |
| | A20 | −0.382183E−05 | −0.382183E−05 | −0.382183E−05 | −0.382183E−05 |
| Optical | Diffraction | 2/1/1 | 2/1/1 | 2/1/1 | 2/1/1 |
| path | order | | | | |
| difference | Design | 395 nm | 395 nm | 395 nm | 395 nm |
| function | wavelength | | | | |
| | B2 | −7.9481E−03 | −7.9481E−03 | −7.9481E−03 | −7.9481E−03 |
| | B4 | 3.1618E−03 | 3.1618E−03 | 3.1618E−03 | 3.1618E−03 |
| | B6 | 2.6104E−04 | 2.6104E−04 | 2.6104E−04 | 2.6104E−04 |
| | B8 | −1.5449E−04 | −1.5449E−04 | −1.5449E−04 | −1.5449E−04 |
| | B10 | 1.3011E−04 | 1.3011E−04 | 1.3011E−04 | 1.3011E−04 |
| Optical | Diffraction | | | | |
| path | order | | | | |
| difference | Design | | | | |
| function | wavelength | | | | |
| | B2 | | | | |
| | B4 | | | | |
| | B6 | | | | |
| | B8 | | | | |
| | B10 | | | | |

TABLE 4

| | | Surface No. | | |
|---|---|---|---|---|
| | | 2-8 | 2-9 | 3 |
| Area | | 1.3466 ≦ h ≦ 1.3751 | 1.3751 ≦ h | |
| Aspheric surface | κ | −0.545757E+00 | −0.616167E+00 | −5.4022E+01 |
| coefficient | A0 | 0.150988E−04 | 0.341800E−01 | 0.0000E+00 |
| | A4 | 0.173456E−01 | 0.132229E−01 | 1.0541E−01 |
| | A6 | 0.161240E−02 | 0.544502E−04 | −1.0213E−01 |
| | A8 | 0.227272E−02 | 0.262231E−02 | 7.4675E−02 |
| | A10 | −0.176212E−02 | −0.156680E−02 | −4.3240E−02 |
| | A12 | 0.832672E−03 | 0.226928E−03 | 1.4629E−02 |
| | A14 | 0.306247E−03 | 0.239248E−03 | −2.0762E−03 |
| | A16 | −0.312510E−03 | −0.165881E−03 | 0.0000E+00 |
| | A18 | 0.779196E−04 | 0.451501E−04 | 0.0000E+00 |
| | A20 | −0.382183E−05 | −0.472873E−05 | 0.0000E+00 |
| Optical path | Diffraction | 2/1/1 | 5/3/2 | |
| difference | order | | | |
| function | Design | 395 nm | 405 nm | |
| | wavelength | | | |
| | B2 | −7.9481E−03 | −1.0012E−03 | |
| | B4 | 3.1618E−03 | −1.0849E−04 | |
| | B6 | 2.6104E−04 | 1.2384E−05 | |
| | B8 | −1.5449E−04 | −5.9681E−06 | |
| | B10 | 1.3011E−04 | −8.9463E−06 | |
| Optical path | Diffraction | | | |
| difference | order | | | |
| function | Design | | | |
| | wavelength | | | |
| | B2 | | | |
| | B4 | | | |
| | B6 | | | |
| | B8 | | | |
| | B10 | | | |

1-27. (canceled)

28. An optical pickup apparatus, comprising:
a first light source to emit a first light flux having a first wavelength λ1;
a second light source to emit a second light flux having a second wavelength λ2 (λ2 >λ1);
a third light source to emit a third light flux having a third wavelength λ3 (λ3>λ2); and
a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3); wherein optical pickup apparatus conducts recording and/or reproducing information by converging the first light flux onto an information recording surface of the first optical disk, by converging the second light flux onto an information recording surface of the second optical disk, and by converging the third light flux onto an information recording surface of the third optical disk;
wherein the light converging optical system includes at least one optical element, the optical element has an optical path difference providing structure on an optical surface thereof, and the optical path difference providing structure is a structure in which at least a first basic structure, a second basic structure and a third basic structure are superimposed on the same surface,
wherein the first basic structure is an optical path difference providing structure to make the amount of r^{th} order diffracted light rays (r is an integer) of the first light flux having passed through the first basic structure larger than the amount of any other-order diffracted light rays, to make the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;
the second basic structure is an optical path difference providing structure to make the amount of u^{th} order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w^{th} order diffracted light rays (w is an integer) of the third light flux larger than the amount of any other order diffracted light rays; and
the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.

29. The optical pickup apparatus described in claim 28, wherein the optical element provided with the optical path difference providing structure constituted by the superimposition of the first basic structure, the second basic structure and the third basic structure is formed by a single material.

30. The optical pickup apparatus described in claim 28, wherein the optical element provided with the optical path difference providing structure constituted by the superimposition of the first basic structure, the second basic structure and the third basic structure is an objective lens made of a plastic.

31. The optical pickup apparatus described in claim 30, wherein the optical pickup apparatus satisfies the following conditional formula;
0.01<ΔSA/f1>0.05 (1)
where ΔSA represents a difference between a spherical aberration at the time of converging the first light flux on an information recording surface of the first optical disk at a standard working temperature T0 (a standard working wavelength λ10 represents the first wavelength λ1 at the standard working temperature T0) and a spherical aberration at the time of converging the first light flux on an information recording surface of the first optical disk at a working temperature T (|T−T0|<60° C.) different from the standard working temperature T0 (a working wavelength λ11 represents the first wavelength λ1 at the working temperature T), and f1 represents a focal length of an objective included in the light converging optical system at the time of using the first light flux.

32. The optical pickup apparatus described in claim 31, wherein a structure to superimpose the third basic structure makes it possible for the value of (ΔSA/f1) to satisfy the conditional formula (1).

33. The optical pickup apparatus described in claim 28, wherein the optical pickup apparatus satisfies the following formulas.
X=1, y=6 and z=5

34. The optical pickup apparatus described in claim 33, wherein the optical pickup apparatus satisfies the following formulas.
r=0, s=0, t=±1, u=2, V=1, W=1, x=10,
y=6 and z=5

35. The optical pickup apparatus described in claim 28, wherein the second basic structure comprises plural steps, the third basic structure comprises plural steps, and a pitch width between steps in the third basic structure is larger than that in the second basic structure, wherein the second basic structure and the third basic structure are superimposed in such a way that the position of at least one step in the second basic structure does not conform with that of one step in the third basic structure.

36. The optical pickup apparatus described in claim 28, wherein at least one of the first basic structure, the second basic structure and the third basic structure is a blaze type shape.

37. The optical pickup apparatus described in claim 28, wherein the optical path providing structure constituted by the superimposition of the first basic structure, the second basic structure and the third basic structure has a slanted plane being not perpendicular and parallel to a base plane of the optical element.

38. An optical element used in a light converging optical system of an optical pickup apparatus which comprises a first light source to emit a first light flux having a first wavelength λ1, a second light source to emit a second light flux having a second wavelength λ2 (λ2>λ1 ), a third light source to emit a third light flux having a third wavelength λ3 (λ3>λ2), and the light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk; the optical element comprising:
an optical path difference providing structure on an optical surface thereof,
wherein the optical path difference providing structure is constituted such that at least a first basic structure, a second basic structure and a third basic structure are superimposed on the same surface,
wherein the first basic structure is an optical path difference providing structure to make the amount of r^{th} order diffracted light rays (r is an integer) of the first light flux having passed through the first basic structure larger than the amount of any other-order diffracted light rays, to makes the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;
the second basic structure is an optical path difference providing structure to make the amount of u^{th} order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w^{th} order diffracted light rays (w is an integer) of the third light flux larger than the amount of any other order diffracted light rays; and
the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.

39. The optical element described in claim 38, wherein the optical element provided with the optical path difference providing structure constituted by the superimposition of the first basic structure, the second basic structure and the third basic structure is formed by a single material.

40. The optical element described in claim 38, wherein the optical element provided with the optical path difference providing structure constituted by the superimposition of the first basic structure, the second basic structure and the third basic structure is an objective lens made of a plastic.

41. The optical element described in claim 40, wherein the optical pickup apparatus satisfies the following conditional formula;
0.01<ΔSA/f1<0.05 (1)
where that ΔSA represents a difference between a spherical aberration at the time of converging the first light flux on an information recording surface of the first optical disk at a standard working temperature T0 (a standard working wavelength λ10 represents the first wavelength λ1 at the standard working temperature T0) and a spherical aberration at the time of converging the first light flux on an information recording surface of the first optical disk at a working temperature T (|T−T0|<60° C.) different from the standard working temperature T0 (a working wavelength λ11 represents the first wavelength λ1 at the working temperature T), and f1 represents a focal length of an objective included in the light converging optical system at the time of using the first light flux.

42. The optical element described in claim 41, wherein a structure to superimpose the third basic structure makes it possible for the value of (ΔSA/f1) to satisfy the conditional formula (1).

43. The optical element described in claim 38, wherein the optical element satisfies the following formulas.
X=10, y=6 and z=5

44. The optical element described in claim 43, wherein the optical pickup apparatus satisfies the following formulas.
r=0, s=0, t=±1, u=2, V=1, W=1, x=10,
y=6 and z=5

45. The optical element described in claim 38, wherein the second basic structure comprises plural steps, the third basic structure comprises plural steps, and a pitch width between steps in the third basic structure is larger than that in the second basic structure, wherein the second basic structure and the third basic structure are superimposed in such a way that the position of at least one step in the second basic structure does not conform with that of one step in the third basic structure.

46. The optical element described in claim 38, wherein at least one of the first basic structure, the second basic structure and the third basic structure is a blaze type shape.

47. The optical element described in claim 38, wherein the optical path providing structure constituted by the superimposition of the first basic structure, the second basic structure and the third basic structure has a slanted plane being not perpendicular and parallel to a base plane of the optical element.

48. An optical information recording reproducing apparatus, comprising:
an optical pickup apparatus which comprises a first light source to emit a first light flux having a first wavelength λ1, a second light source to emit a second light flux having a second wavelength λ2 (λ2 >λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;
wherein the light converging optical system of the optical pickup apparatus includes at least one optical element,
the optical element has an optical path difference providing structure on an optical surface thereof, and
the optical path difference providing structure is constituted such that at least a first basic structure, a second basic structure and a third basic structure are superimposed on the same surface,
wherein the first basic structure is an optical path difference providing structure to make the amount of r^{th} order diffracted light rays (r is an integer) of the first light flux having passed through the first basic structure larger than the amount of any other-order diffracted light rays, to make the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;
the second basic structure is an optical path difference providing structure to make the amount of Uh order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w order diffracted light rays (w is an integer) of the third light flux larger than the amount of any other order diffracted light rays; and
the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.

49. An optical pickup apparatus, comprising:
a first light source to emit a first light flux having a first wavelength λ1,
a second light source to emit a second light flux having a second wavelength λ2 (λ2>λ1),
a third light source to emit a third light flux having a third wavelength λ3 (λ3>λ2), and
a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), wherein the optical pickup apparatus conducts recording and/or reproducing information by converging the first light flux onto an information recording surface of the first optical disk, by converging the second light flux onto an information recording surface of the second optical disk, and by converging the third light flux onto an information recording surface of the third optical disk;
wherein the light converging optical system includes at least one optical element,
the optical element has an optical path difference providing structure on an optical surface thereof, and
the optical path difference providing structure is constituted such that at least a first basic structure, a second basic structure and a third basic structure are superimposed on the same surface,
wherein the first basic structure, the second basic structure and the third basic structure is a structure having steps shaped in almost the same direction as that of the optical axis, at least one of the first basic structure, the second basic structure and the third basic structure is a structure having a blaze type shape, and the optical path providing structure constituted by the superimposition of the first basic structure, the second basic structure and the third basic structure has a slanted plane being not perpendicular and parallel to a base plane of the optical element.

50. The optical pickup apparatus described in claim 49, wherein at least one of the first basic structure, the second basic structure and the third basic structure has a stairs type shape.

51. An optical element used in an light converging optical system of an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk; the optical element comprising:
an optical path difference providing structure on an optical surface thereof,
wherein the optical path difference providing structure is constituted such that at least a first basic structure, a second basic structure and a third basic structure are superimposed on the same surface,
wherein the first basic structure, the second basic structure and the third basic structure is a structure having steps shaped in the same direction as that of the optical axis, at least one of the first basic structure, the second basic structure and the third basic structure is a structure having a blaze type shape, and the optical path providing structure constituted by the superimposition of the first basic structure, the second basic structure and the third basic structure has a slanted plane being not perpendicular and parallel to a base plane of the optical element.

52. The optical element described in claim 51, wherein at least one of the first basic structure, the second basic structure and the third basic structure has a stairs type shape.

53. An optical information recording and reproducing apparatus, comprising:
an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and a light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk;
wherein the light converging optical system includes at least one optical element,
the optical element has an optical path difference providing structure on an optical surface thereof, and
the optical path difference providing structure is constituted such that at least a first basic structure, a second basic structure and a third basic structure are superimposed on the same surface,
wherein the first basic structure, the second basic structure and the third basic structure is a structure having steps shaped in the same direction as that of the optical axis, at least one of the first basic structure, the second basic structure and the third basic structure is a structure having a blaze type shape, and the optical path providing structure constituted by the superimposition of the first basic structure, the second basic structure and the third basic structure has a slanted plane being not perpendicular and parallel to a base plane of the optical element.

54. A method of designing an optical element comprising an optical path difference providing structure and used in a light converging optical system of an optical pickup apparatus which comprises a first light source to emit a first light flux having a first wavelength λ1, a second light source to emit a second light flux having a second wavelength λ2 (λ2>λ1), a third light source to emit a third light flux having a third wavelength λ3 (λ3>λ2), and the light converging optical system to converge the first light flux onto an information recording surface of a first optical disk with a protective substrate having a thickness of t1, to converge the second light flux onto an information recording surface of a second optical disk with a protective substrate having a thickness of t2 (t1≦t2), and to converge the third light flux onto an information recording surface of a third optical disk with a protective substrate having a thickness of t3 (t2<t3), and which conducts recording and/or reproducing information by converging the first light flux onto an information recording surface of the first optical disk, by converging the second light flux onto an information recording surface of the second optical disk, and by converging the third light flux onto an information recording surface of the third optical disk; the method comprising:
a process of designing a first basic structure;
a process of designing a second basic structure;
a process of designing a third basic structure; and
a process of designing the optical path difference providing structure by superimposing at least the first basic structure, the second basic structure and the third basic structure;
wherein the first basic structure is an optical path difference providing structure to make the amount of r^{th} order diffracted light rays (r is an integer) of the first light flux having passed through the first basic structure larger than the amount of any other-order diffracted light rays, to makes the amount of s^{th} order diffracted light rays (s is an integer) of the second light flux larger than the amount of any other-order diffracted light rays, and to make the amount of t^{th} order diffracted light rays (t is an integer) of the third light flux larger than the amount of any other order diffracted light rays;
the second basic structure is an optical path difference providing structure to make the amount of u^{th} order diffracted light rays (u is an integer) of the first light flux having passed through the second basic structure larger than the amount of any other order diffracted light rays, to make the amount of v^{th} order diffracted light rays (v is an integer) of the second light flux larger than the amount of any other order diffracted light rays, and to make the amount of w^{th} order diffracted light rays (w is an integer) of the third light flux larger than the amount of any other order diffracted light rays; and
the third basic structure is an optical path difference providing structure to make the amount of x^{th} order diffracted light rays (x is an integer) of the first light flux having passed through the third basic structure larger than the amount of any other-order diffracted light rays, to make the amount of y^{th} order diffracted light rays (y is an integer) of the second light flux larger than the amount of any other order diffracted light rays, and to make the amount of z^{th} order diffracted light rays (z is an integer) of the third light flux larger than the amount of any other-order diffracted light rays.
